(19) United States
(12) Patent Application Publication
(10) Pub. No.: US 2025/0105724 A1
(43) Pub. Date: Mar. 27, 2025

(54) POWER CONVERSION DEVICE AND DRIVE DEVICE

(71) Applicant: HITACHI ASTEMO, LTD., Hitachinaka-shi, Ibaraki (JP)

(72) Inventors: Ryoichi INADA, Chiyoda-ku, Tokyo (JP); Hiroshi NAKANO, Chiyoda-ku, Tokyo (JP); Nobuyasu KANEKAWA, Chiyoda-ku, Tokyo (JP); Satoru SHIGETA, Hitachinaka-shi, Ibaraki (JP)

(73) Assignee: HITACHI ASTEMO, LTD., Hitachinaka-shi, Ibaraki (JP)

(21) Appl. No.: 18/730,599

(22) PCT Filed: Dec. 27, 2022
(86) PCT No.: PCT/JP2022/048413

§ 371 Date: Jul. 19, 2024

(30) Foreign Application Priority Data
Mar. 10, 2022 (JP) 2022-037581

(51) Int. Cl. H02M 1/32; H02M 7/483

(52) U.S. Cl. CPC H02M 1/325; H02M 7/483

(57) ABSTRACT

This power conversion device comprises: a power conversion circuit in which at least three-phases of upper/lower arm circuits having switching elements connected in series are connected in parallel and which outputs AC current to a motor via an output line, said AC current being generated by the switching elements of each phase; a breaker that is provided on the output line of each phase and allows the AC current to flow or interrupts the AC current; a first failure location determination unit that determines a failure location of the switching elements; a breaker control unit that sets, as a failure phase, a phase corresponding to the switching element determined as the failure location by the first failure location determination unit and controls the breaker of the failure phase so that the AC current of the failure phase is allowed to flow at a predetermined specific electric angle in one electric angle cycle and the AC current of the failure phase is interrupted at another electric angle except the specific electric angle; and a failure-time current control unit that controls the drive of other switching elements different from the switching element determined as the failure location.

### TECHNICAL FIELD

The present invention relates to a power conversion device and a drive device.

### BACKGROUND ART

When a short-circuit failure is generated in the switching elements configuring an inverter, current of the failure phase cannot be controlled, and there is a possibility that motor output torque becomes excessive or winding burnout of a motor is caused. For this reason, a technique in which the current of the failure phase at the time of the short-circuit failure is cut off using a circuit breaker or the like is known.

PTL 1 describes an invention of an electric power steering device that turns off the circuit breaker of the failure phase and drives normal switching elements of two phases to continue motor driving when the switching element or the motor fails.

### CITATION LIST

### Patent Literature

PTL 1: JP 2009-6963 A

### SUMMARY OF INVENTION

### Technical Problem

In the electric power steering device described in PTL 1, because the output torque decreases to 0 [Nm] at two electrical angles during one cycle of an electrical angle, the average output torque decreases as compared with a normal time. In order to increase the average output torque, it is necessary to increase the normal two-phase torque, but when this is performed, there is a problem that the torque fluctuation increases.

### Solution to Problem

A power conversion device according to the present invention includes: a power conversion circuit in which upper and lower arm circuits in which switching elements are connected in series are connected in parallel for three phases, the power conversion circuit outputting an AC current generated by the switching elements of each phase to a motor through an output line; a circuit breaker provided on the output line of each phase to conduct or cut off the AC current; a first failure portion determination unit that determines a failure portion of the switching element; a circuit breaker controller that controls the circuit breaker of a failure phase such that the AC current of the failure phase is conducted at a predetermined specific electrical angle in one cycle of an electrical angle and such that the AC current of the failure phase is cut off at other electrical angles except for the specific electrical angle, with a phase corresponding to the switching element determined as the failure portion by the first failure portion determination unit as the failure phase; and a failure-time current controller that controls drive of another switching element different from the switching element determined to be the failure portion.

A drive device according to the present invention includes: a power conversion device that outputs a three-phase AC current; and a motor that is driven by the three-phase AC current, in which the power conversion device includes: a power conversion circuit in which upper and lower arm circuits in which switching elements are connected in series are connected in parallel for at least three phases, the power conversion circuit outputting an AC current generated by the switching elements of each phase to a motor through an output line; a circuit breaker provided on the output line of each phase to conduct or cut off the AC current; a first failure portion determination unit that determines a failure portion of the switching element; a circuit breaker controller that controls the circuit breaker of a failure phase such that the AC current of the failure phase is conducted at a predetermined specific electrical angle in one cycle of an electrical angle and such that the AC current of the failure phase is cut off at other electrical angles except for the specific electrical angle, with a phase corresponding to the switching element determined as the failure portion by the first failure portion determination unit as the failure phase; and a failure-time current controller that controls drive of another switching element different from the switching element determined to be the failure portion.

### Advantageous Effects of Invention

Even after the switching element failure, motor drive can be continued while torque fluctuation is prevented.

### BRIEF DESCRIPTION OF DRAWINGS

FIG. 1 illustrates an example of a vehicle on which a drive device is mounted.

FIG. 2 illustrates a configuration example of a power conversion device and a drive device according to the first embodiment of the present invention.

FIG. 3 illustrates a configuration example of a power conversion circuit and a motor.

FIG. 4 illustrates a configuration example of a circuit breaker using a semiconductor switch.

FIG. 5 illustrates an example of internal state determination of a state determination unit according to the first embodiment of the present invention.

FIG. 6 illustrates an example of a specific electrical angle at which a circuit breaker of a failure phase is brought into a conduction state.

FIG. 7 illustrates an example of a control flowchart according to the first embodiment of the present invention.

FIG. 8 illustrates an example of output torque at the time of a one-phase failure according to the first embodiment of the present invention.

FIG. 9 is an explanatory diagram illustrating switching timing of a circuit breaker according to a second embodiment of the present invention.

FIG. 10 illustrates a configuration example of a power conversion device and a drive device according to a third embodiment of the present invention.

FIG. 11 is an explanatory diagram illustrating switching timing of a circuit breaker according to the third embodiment of the present invention.

FIG. 12 illustrates an example of a control flowchart according to the third embodiment of the present invention.

FIG. 13 is an explanatory diagram illustrating switching timing of a circuit breaker according to a fourth embodiment of the present invention.

FIG. 14 illustrates an example of a control flowchart according to the fourth embodiment of the present invention.

FIG. 15 illustrates a configuration example of a power conversion device and a drive device according to a fifth embodiment of the present invention.

FIG. 16 illustrates an example of internal state determination of a state determination unit according to the fifth embodiment of the present invention.

FIG. 17 illustrates an example of a flowchart of a circuit breaker diagnosis according to the fifth embodiment of the present invention.

FIG. 18 illustrates an example of a control flowchart according to the fifth embodiment of the present invention.

### DESCRIPTION OF EMBODIMENTS

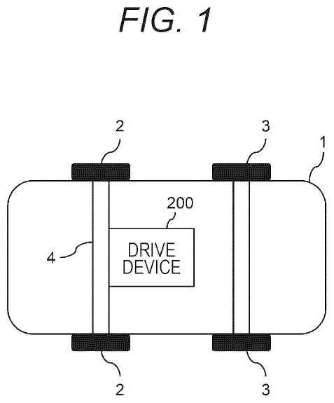

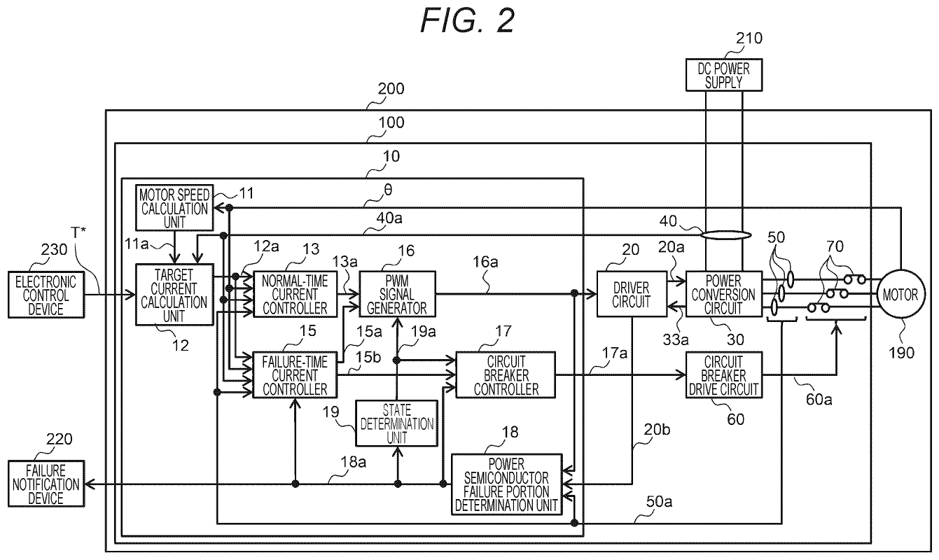

FIG. 1 is a view illustrating an example of a vehicle on which a drive device of the present invention is mounted. A vehicle 1 illustrated in FIG. 1 is equipped with a drive device 200 while including driving wheels 2 and non-driving wheels 3. The drive device 200 is connected to an axle 4 in which driving wheels 2 are attached to both ends of the axle 4, and includes a power conversion device 100 and a motor 190 (see FIG. 2) in the drive device 200. In accordance with operation of an accelerator pedal by a driver, the power conversion device 100 and the motor 190 are controlled to generate driving force, and the driving force is transmitted to the axle 4. Thus, the driving wheels 2 are driven to cause the vehicle 1 to travel. In addition, a speed reducer may be disposed in the drive device, and the driving force of the motor 190 may be transmitted to the axle 4 through the speed reducer.

In FIG. 1, a front wheel of the vehicle 1 is the driving wheel 2, a rear wheel is the non-driving wheel 3, and the drive device 200 is connected to the axle 4 on the front wheel side. However, the drive device 200 may be connected to the axle on the rear wheel side with the rear wheel as the driving wheel. In addition, the drive device 200 may be connected to each axle using all the front and rear wheels as driving wheels, or independent drive devices 200 may be installed and connected to the left and right driving wheels instead of the axle.

Subsequently, each embodiment of the power conversion device 100 and the drive device 200 will be described below.

### First Embodiment

FIG. 2 is a view illustrating a configuration example of the power conversion device 100 and the drive device 200 according to a first embodiment of the present invention. The first embodiment illustrates an example of the power conversion device and the drive device that improve average output torque while maintaining a torque fluctuation and facilitate starting of the vehicle when a power semiconductor fails.

The drive device 200 includes the power conversion device 100 and the motor 190. The motor 190 is a three-phase AC motor having three windings inside, and for example, corresponds to a synchronous motor using a permanent magnet or an induction motor not using a permanent magnet. An angle sensor (not illustrated) that measures an electric angle of the motor is mounted on the motor 190, and the angle sensor outputs the measured electric angle to the power conversion device 100 as an angle sensor value θ.

An electronic control device 230, a DC power supply 210, and a failure notification device 220 are provided around the drive device 200. The electronic control device 230 transmits information such as target torque T* to the drive device 200. The DC power supply 210 is a power supply that drives the motor 190, and for example, corresponds to a battery. The failure notification device 220 receives a failure notification signal from the drive device 200 and notifies a passenger of the generation of the failure. Examples of a failure notification method include a method for turning on a lamp, a method for generating a warning sound, and a method for notifying the passenger by voice.

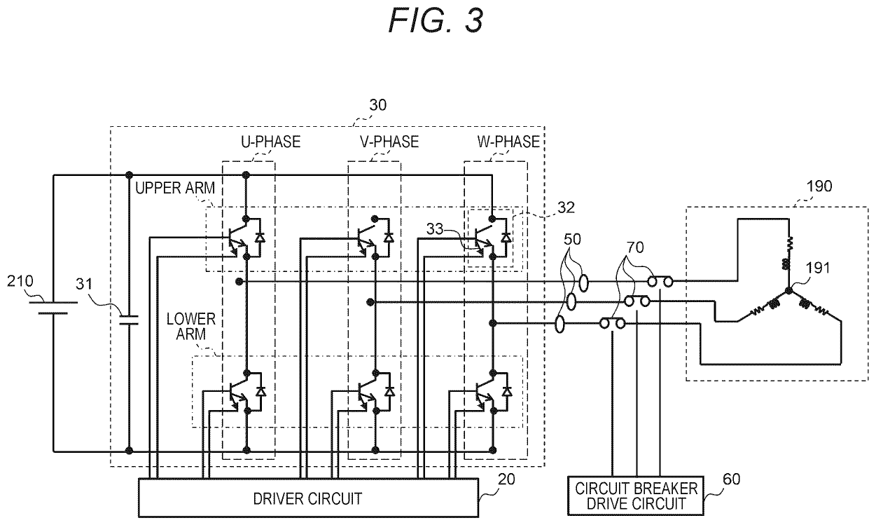

The power conversion device 100 converts DC power obtained from the DC power supply 210 into AC power to drive the motor 190. The power conversion device 100 also has a function of converting power of the motor 190 into the DC power to charge the DC power supply 210. The power conversion device 100 internally includes a control circuit 10, a driver circuit 20, a power conversion circuit 30, a voltage sensor 40, an AC current sensor 50, a circuit breaker drive circuit 60, and a circuit breaker 70. The power conversion circuit 30 receives a driving signal 20a from the driver circuit 20, drives the internal power semiconductor, and controls the current that flows through the motor 190. The circuit breaker drive circuit 60 drives the circuit breaker 70 to cut off the connection between the power conversion circuit 30 and the motor 190. The internal configuration of the power conversion circuit 30 will be described first with reference to FIG. 3, and the internal configuration and other configurations of the control circuit 10 will be described later.

FIG. 3 is a view illustrating a configuration example of the power conversion circuit 30 and the motor 190. The power conversion circuit 30 internally includes a smoothing capacitor 31 and six power semiconductor elements 32.

The smoothing capacitor 31 is a capacitor that smoothes the current generated by turning on and off the power semiconductor element 32 and prevents a ripple of the DC current supplied from the DC power supply 210 to the power conversion circuit 30. For example, an electrolytic capacitor or a film capacitor is used as the smoothing capacitor 31.

The power semiconductor element 32 is a switching element that switches on and off according to the driving signal 20a input from the driver circuit 20, and converts the DC power and the AC power. For example, the power semiconductor element 32 corresponds to a power metal oxide semiconductor field effect transistor (MOSFET) or an insulated gate bipolar transistor (IGBT). In addition, the power semiconductor element 32 includes a sense terminal 33. From the sense terminal 33, a current of a certain ratio, for example, 1/100 or 1/1000 of the current flowing between the collector and the emitter (between a drain and a source) of the power semiconductor element 32 is output as a sense current. The sense current is output from the power conversion circuit 30 to the driver circuit 20. In the following embodiment, an example in which the IGBT is used as the power semiconductor element 32 will be described.

The six power semiconductor elements 32 are divided into upper and lower two for each phase, and the output is connected to the winding of each phase of the motor 190. Hereinafter, the upper three power semiconductor elements 32 are collectively referred to as an upper arm, and the lower three power semiconductor elements 32 are collectively referred to as a lower arm. That is, upper and lower arm circuits in which the two power semiconductor elements 32 of the upper and lower arms are connected in series for each phase (U-phase, V-phase, W-phase) of the motor 190 are provided in the power conversion circuit 30. The power conversion circuit 30 includes wirings connected to a positive electrode side and a negative electrode side of the DC power supply 210, and upper and lower arm circuits of each phase are connected in parallel between the wirings.

In the first embodiment, a motor neutral point 191 is in a floating state, but may be connected to the ground (not illustrated). Methods for connecting the motor neutral point 191 to the ground include a direct grounding method, a resistance grounding method, a compensation reactor grounding method, an arc-extinguishing reactor grounding method, and the like.

Returning to FIG. 2, the configuration of the first embodiment will be described. The voltage sensor 40 is a sensor that measures the output voltage of the DC power supply 210, and outputs the measured voltage value to the control circuit 10 as a voltage sensor value 40a.

The AC current sensor 50 is a sensor that measures an AC current flowing through each phase (U-phase, V-phase, W-phase) of the motor 190, and outputs a measured AC current of each phase to the control circuit 10 as an AC current sensor value 50a. In the first embodiment, a total of three AC current sensors 50 are provided for each phase, but the AC current sensors may be provided for only two phases. In this case, because a relationship of U-phase current+V-phase current+W-phase current=0 holds, the control circuit 10 calculates the AC current sensor value for the remaining one phase. In the first embodiment, the current flowing from the power conversion circuit 30 to the motor 190 is treated as a positive current, and the current flowing from the motor 190 to the power conversion circuit 30 is treated as a negative current.

The driver circuit 20 receives a pulse width modulation (PWM) signal 16a output from a PWM signal generator 16 to be described later, and outputs the driving signal 20a that switches on and off of the power semiconductor element 32. In addition, the driver circuit 20 detects the generation of a short-circuit failure in the power semiconductor element 32 using a sense current 33a output from the power semiconductor element 32, and outputs a short-circuit failure detection signal 20b to the control circuit 10.

Normally, the PWM signal 16a is generated such that the upper and lower power semiconductor elements 32 are not simultaneously turned on. However, in the case where the short-circuit failure is generated in the power semiconductor element 32, the upper and lower power semiconductor elements 32 can be simultaneously turned on. When the upper and lower power semiconductor elements 32 are simultaneously turned on, a large through current flows through the power semiconductor element 32. The driver circuit 20 monitors whether the sense current 33a of each power semiconductor element 32 is equal to or larger than a certain threshold, and determines that the short-circuit failure is generated in the power semiconductor element 32 in the corresponding phase in the case where the sense current 33a is equal to or larger than the certain value. The driver circuit 20 outputs the short-circuit failure detection signal 20b divided for each phase.

In the first embodiment, the short-circuit failure of the power semiconductor element 32 is determined using the sense current 33a of the power semiconductor element 32. However, the short-circuit failure of the power semiconductor element 32 may be detected by another method. For example, there is a method in which a shunt resistor for current measurement is disposed on the collector side or the emitter side of the power semiconductor element 32 and a current value flowing through the shunt resistor is measured to detect the short-circuit failure of the power semiconductor element 32. In addition, because a collector-emitter voltage of the power semiconductor element 32 increases according to the flowing current, there is also a method for measuring the collector-emitter voltage to detect the short-circuit failure of the power semiconductor element 32.

The circuit breaker drive circuit 60 receives a circuit breaker control signal 17a output from a circuit breaker controller 17 to be described later, and outputs a circuit breaker driving signal 60a that switches a conduction or cutoff state of the circuit breaker 70.

The circuit breaker 70 is provided on an output line of each phase that connects the power conversion circuit 30 and the winding of the motor 190, and switches the conduction or cutoff state according to the circuit breaker driving signal 60a to conduct or cut off the AC current that flows from the power conversion circuit 30 to the winding of the motor 190 through the output line of each phase. When the circuit breaker 70 is in the conduction state, the AC current flows between the power conversion circuit 30 and the winding of the motor 190. When the circuit breaker 70 is in the cutoff state, the current does not flow. In the first embodiment, the circuit breaker 70 is installed for each phase of the motor 190.

Although the circuit breaker 70 is disposed in the power conversion device 100 in the first embodiment, the circuit breaker 70 may be disposed in the motor 190, or disposed independently of the power conversion device 100 and the motor 190. However, when the circuit breaker 70 is installed in the motor 190, it is necessary to disassemble the motor 190 at the time of replacing the circuit breaker 70. Consequently, installing the circuit breaker 70 in the power conversion device 100 facilitates replacement work of the circuit breaker 70.

For example, a mechanical switch such as a relay or a semiconductor switch such as the IGBT or the MOSFET can be used as the circuit breaker 70. The semiconductor switch has a feature that switching of the conduction or cutoff state is faster than that of the mechanical switch. On the other hand, even when the semiconductor switch is turned off, the current may flow through an internal freewheeling diode. For this reason, in the case where the semiconductor switch is used for the circuit breaker 70, it is necessary to adopt a configuration that reliably cuts off the current when the semiconductor switch is switched off.

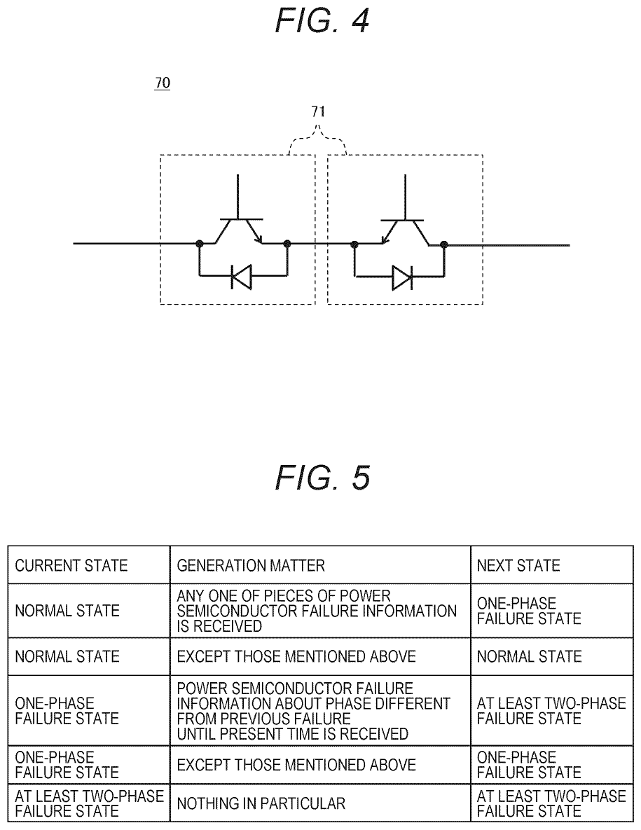

FIG. 4 is a view illustrating a configuration example of the circuit breaker 70 using the semiconductor switch. For example, as illustrated in FIG. 4, the circuit breaker 70 capable of cutting off the current flowing in both directions can be implemented by connecting the two semiconductor switches 71 in series in opposite directions to each other.

On the other hand, although the switching time of the mechanical switch is longer than that of the semiconductor switch, the bidirectional current can be reliably cut off by one switch. For this reason, the mechanical switch is superior to the semiconductor switch in terms of cost.

The configuration of the circuit breaker 70 is not limited to the semiconductor switch or the mechanical switch having the circuit configuration in FIG. 4. When the AC current that is output from the power conversion circuit 30 and flows through the winding of the motor 190 can be reliably conducted or cut off, the circuit breaker 70 can be implemented by an arbitrary circuit configuration.

The control circuit 10 communicates with the external electronic control device 230 and receives the target torque T* of the motor 190 from the electronic control device 230. In the case where the power conversion device 100 is normal, the control circuit 10 outputs the PWM signal 16a so as to control the current of each phase output from the power conversion device 100 to a predetermined value based on the target torque T*, and drives the power conversion circuit 30 through the driver circuit 20. In the case where determining that the failure is generated in the power conversion device 100, the control circuit 10 outputs the failure notification signal to the external failure notification device 220.

The control circuit 10 internally includes a CPU, a RAM, a ROM, and a communication circuit (not illustrated). The ROM may be an electrically erasable programmable ROM (EEPROM) or a flash ROM that is electrically rewritable. In addition, the control circuit 10 may include a logic circuit configured using hardware such as a field programmable gate array (FPGA).

In addition, the control circuit 10 includes functional blocks of a motor speed calculation unit 11, a target current calculation unit 12, a normal-time current controller 13, a failure-time current controller 15, the PWM signal generator 16, the circuit breaker controller 17, a power semiconductor failure portion determination unit 18, and a state determination unit 19. For example, these functional blocks may be implemented by the CPU executing a predetermined program in the control circuit 10, or a part or all of them may be implemented by hardware such as the FPGA.

The motor speed calculation unit 11 calculates a motor rotation speed (rotation speed) from the change in the angle sensor value θ of the motor 190, and outputs a calculated motor speed value 11a to the target current calculation unit 12.

The target current calculation unit 12 output a target current value 12a to the normal-time current controller 13 using the target torque T*, the voltage sensor value 40a, and the motor speed value 11a that is output from the motor speed calculation unit 11. The target current value 12a is calculated as a current value that should be supplied to the motor 190 in order that the motor 190 outputs the same torque as the target torque T*. For example, the target current value 12a is expressed in the form of a d-axis target current value and a q-axis target current value.

The normal-time current controller 13 calculates a duty value 13a of each phase using the target current value 12a and the motor angle sensor value θ that are output by the target current calculation unit 12, the AC current sensor value 50a of each phase, and the voltage sensor value 40a, and outputs the duty value 13a to the PWM signal generator 16. Details of a method for calculating the duty value 13a by the normal-time current controller 13 will be described later.

The failure-time current controller 15 calculates the duty value 15a of each phase and the circuit breaker switching signal 15b that controls the state of the circuit breaker 70 at the time of failure using the target current value 12a output from the target current calculation unit 12, the motor angle sensor value θ, the AC current sensor value 50a of each phase, the voltage sensor value 40a, and the power semiconductor failure information 18a output from the power semiconductor failure portion determination unit 18. Then, the calculated duty value 15a and the circuit breaker switching signal 15b are output to the PWM signal generator 16 and the circuit breaker controller 17, respectively. Details of a method for calculating the duty value 15a and the circuit breaker switching signal 15b by the failure-time current controller 15 will be described later.

The PWM signal generator 16 switches the signal that is output to the driver circuit 20 according to an internal state 19a output from the state determination unit 19. The PWM signal generator 16 internally includes a timer. In the case where the internal state 19a is a “normal state”, the PWM signal generator 16 generates the PWM signal 16a using the timer value and the duty value 13a of each phase output from the normal-time current controller 13, and outputs the PWM signal 16a to the driver circuit 20. In the case where the internal state 19a is a “one-phase failure state” to be described later, the PWM signal generator 16 generates the PWM signal 16a using the timer value and the duty value 15a of each phase that is output by the failure-time current controller 15, and outputs the PWM signal 16a to the driver circuit 20. In the case where the internal state 19a is “at least two-phase failure state” to be described later, the PWM signal generator 16 outputs the PWM signal 16a that does not drive the motor 190 to the driver circuit 20. For example, the state in which the motor 190 is not driven includes a state in which all the six power semiconductor elements 32 in the power conversion circuit 30 are turned off (referred to as a free wheel state in the first embodiment).

The circuit breaker controller 17 generates and outputs the circuit breaker control signal 17a that switches the conduction or cutoff of the circuit breaker 70 of each phase using the internal state 19a output from the state determination unit 19, the power semiconductor failure information 18a output from the power semiconductor failure portion determination unit 18, and the circuit breaker switching signal 15b output from the failure-time current controller 15. Details of a method for calculating the circuit breaker control signal 17a by the circuit breaker controller 17 will be described later.

The power semiconductor failure portion determination unit 18 determines a failure portion and a failure mode of the power semiconductor element 32 based on the PWM signal 16a, the short-circuit failure detection signal 20b output from the driver circuit 20, and the AC current sensor value 50a of each phase. The failure mode of the power semiconductor element 32 is roughly divided into two types of the short-circuit failure and an open failure. In the case of the short-circuit failure, the power semiconductor element 32 is always in an on-state. In the case of the open failure, the power semiconductor element 32 is always in an off-failure. In the case where the short-circuit failure detection signal 20b is output from the driver circuit 20, the power semiconductor failure portion determination unit 18 determines that the short-circuit failure is generated. In the case where the AC current sensor value 50a of each phase does not change within a predetermined value, the power semiconductor failure portion determination unit 18 determines that the open failure is generated.

Because the short-circuit failure detection signal 20b output from the driver circuit 20 at the time of the generation of the short-circuit failure is divided for each phase, the power semiconductor failure portion determination unit 18 can specify which phase the failure is generated from the short-circuit failure detection signal 20b, but cannot specify which of the upper and lower arms fails. For this reason, for example, the power semiconductor failure portion determination unit 18 compares the timing at which the short-circuit failure detection signal 20b is output with the state of the PWM signal 16a, and determines that the short-circuit failure is generated in the arm in which the short-circuit failure detection signal 20b is in an off-state among the PWM signals 16a of the upper and lower arms in the phase in which the failure is generated. This is because the upper and lower power semiconductor elements 32 are not normally simultaneously turned on, and thus, the detection of the short-circuit failure of the power semiconductor element 32 is considered that the upper and lower power semiconductor elements 32 are simultaneously turned on because the short-circuit failure is generated in the power semiconductor element 32 originally supposed to be in the off-state. In the case where determining that the short-circuit failure of the power semiconductor element 32 is generated, the power semiconductor failure portion determination unit 18 outputs the power semiconductor failure information 18a indicating the failure portion and the failure mode to the failure-time current controller 15, the circuit breaker controller 17, the state determination unit 19, and the external failure notification device 220.

In addition, when the open failure is generated, the power semiconductor failure portion determination unit 18 can specify which phase the failure is generated from the AC current sensor value 50a of each phase output by the AC current sensor 50, but cannot specify which of the upper and lower arms fails. For this reason, for example, the power semiconductor failure portion determination unit 18 divides the AC current sensor value 50a of each phase into a positive current value and a negative current value, smooths each value, and compares each value with a predetermined threshold, thereby determining which one of the upper and lower arms has the open failure. When determining that the open failure of the power semiconductor element 32 is generated, the power semiconductor failure portion determination unit 18 outputs the power semiconductor failure information 18a indicating the failure portion and the failure mode to the failure-time current controller 15, the circuit breaker controller 17, the state determination unit 19, and the external failure notification device 220.

The state determination unit 19 determines whether the state of the power conversion device 100 is any one of the “normal state”, the “one-phase failure state”, and the “at least two-phase failure state” based on the power semiconductor failure information 18a output from the power semiconductor failure portion determination unit 18. Then, the internal state 19a representing the current state of the power conversion device 100 is output to the PWM signal generator 16 and the circuit breaker controller 17.

FIG. 5 is a view illustrating an example of internal state determination of the state determination unit 19 according to the first embodiment of the present invention. The state determination unit 19 determines a next state from a current state and a generation matter at regular time intervals, and updates the next state to the current state. An initial state is the “normal state”. In a case where the current state is the “normal state”, the state determination unit 19 changes the next state to the “one-phase failure state” when receiving the power semiconductor failure information 18a indicating that the power semiconductor element 32 of any phase fails from the power semiconductor failure portion determination unit 18. Otherwise, the next state remains in the “normal state”. In addition, the state determination unit 19 changes the next state to the “at least two-phase failure state” when receiving the power semiconductor failure information 18a indicating that the power semiconductor element 32 of the phase different from the previous failure phase fails from the power semiconductor failure portion determination unit 18 while the current state is the “one-phase failure state”. For example, when the new notification of the power semiconductor failure information 18a for the power semiconductor element 32 of the V-phase or W-phase is performed while the current state is the “one-phase failure state” due to the failure of the power semiconductor element 32 of the U-phase, the next state is changed to the “at least two-phase failure state”. Otherwise, the next state remains the “one-phase failure state”. In the case where the current state is the “at least two-phase failure state”, the state determination unit 19 keeps the next state as the “at least two-phase failure state”.

Current control during the normal operation and current control at the time of the one-phase failure performed by the normal-time current controller 13 and the failure-time current controller 15, respectively, will be described below. In the first embodiment, an example in which a coefficient of the absolute transform is used at the time of axis transform is illustrated. However, a coefficient of relative transform may be used.

In the current control in the normal state, first, the target current calculation unit 12 in FIG. 2 determines the d-axis target current value and the q-axis target current value according to the target torque T*. Subsequently, the normal-time current controller 13 calculates the duty value 13a of each phase that achieves the d-axis target current value and the q-axis target current value that are determined by the target current calculation unit 12. Then, the PWM signal generator 16 generates the PWM signal 16a of each phase according to the duty value 13a of each phase calculated by the normal-time current controller 13. At this time, the circuit breaker controller 17 controls all the three-phase circuit breakers 70 to be in the conduction state.

The normal-time current controller 13 converts the three-phase AC current sensor values 50a output from the AC current sensor 50 into d-axis and q-axis current values using [Mathematical Formula 1]. Iu, Iv, and Iw in [Mathematical Formula 1] are AC current sensor values of the U-phase, the V-phase, and the W-phase, respectively, and θ is the angle sensor value. In addition, Id represents a d-axis current value after conversion, and Iq represents a q-axis current value after conversion.

$$[ \begin{matrix}{I}_{a} \\ {I}_{q}\end{matrix} ] = \sqrt{\frac{2}{3}} [ \begin{matrix}cos ( θ ) & cos ( θ - \frac{2}{3} π ) & cos ( θ + \frac{2}{3} π ) \\ - sin ( θ ) & - sin ( θ - \frac{2}{3} π ) & - sin ( θ + \frac{2}{3} π )\end{matrix} ] [ \begin{matrix}{I}_{u} \\ {I}_{v} \\ {I}_{w}\end{matrix} ] \qquad [ Mathematical Formula 1 ]$$

Subsequently, the normal-time current controller 13 obtains a difference between the d-axis current and the d-axis target current value and a difference between the q-axis current and the q-axis target current value. Then, the normal-time current controller 13 performs feedback control on the d-axis current difference and the q-axis current difference to determine a d-axis target voltage value and a q-axis target voltage value. The normal-time current controller 13 converts the d-axis target voltage value and the q-axis target voltage value into the form of an α-axis target voltage value and a β-axis target voltage value using [Mathematical Formula 2] such that the d-axis target voltage value and the q-axis target voltage value become the values of an α-axis and a β-axis. In [Mathematical Formula 2], Vd is the d-axis target voltage value, Vq is the q-axis target voltage value, θ is the angle sensor value, Vα is the α-axis target voltage value, and Vβ is the β-axis target voltage value.

$$[ \begin{matrix}{V}_{α} \\ {V}_{β}\end{matrix} ] = [ \begin{matrix}cos θ & - sin θ \\ sin θ & cos θ\end{matrix} ] [ \begin{matrix}{V}_{d} \\ {V}_{q}\end{matrix} ] \qquad [ Mathematical Formula 2 ]$$

Then, the normal-time current controller 13 converts the α-axis target voltage value and the β-axis target voltage value into target voltage values of the U-phase, the V-phase, and the W-phase using [Mathematical Formula 3]. In [Mathematical Formula 3], Va is the α-axis target voltage value, Vβ is the β-axis target voltage value, Vu is a U-phase target voltage value, Vv is a V-phase target voltage value, and Vw is a W-phase target voltage value.

$$[ \begin{matrix}{V}_{u} \\ {V}_{v} \\ {V}_{w}\end{matrix} ] = \sqrt{\frac{2}{3}} [ \begin{matrix}1 & 0 \\ - \frac{1}{2} & \frac{\sqrt{3}}{2} \\ - \frac{1}{2} & - \frac{\sqrt{3}}{2}\end{matrix} ] [ \begin{matrix}{V}_{α} \\ {V}_{β}\end{matrix} ] \qquad [ Mathematical Formula 3 ]$$

Finally, the normal-time current controller 13 calculates the duty value 13a of each phase from the target voltage value of each phase and the voltage sensor value 40a.

In the current control at the time of the one-phase failure, first, the target current calculation unit 12 determines the d-axis target current value and the q-axis target current value according to the target torque T* similarly to the normal state. Subsequently, in the failure-time current controller 15, the duty value 13a of the failure phase is calculated such that one of the power semiconductor elements 32 of the upper and lower arms of the failure phase is always turned on and the other is always turned off. Specifically, in the case of the short-circuit failure, the failure-time current controller 15 calculates the duty value 13a of the power semiconductor element 32 as zero such that the power semiconductor element 32 in phase with the failure portion indicated by the power semiconductor failure information 18a and on the upper and lower opposite arm sides is always in the off-state. In addition, in the case of the open failure, the failure-time current controller 15 calculates the duty value 13a of the power semiconductor element 32 to 1 such that the power semiconductor element 32 in phase with the failure portion indicated by the power semiconductor failure information 18a and on the opposite side of the upper and lower arms is always in the on-state.

In addition, the failure-time current controller 15 corrects the target voltage in a conversion portion from the α-axis target voltage value (Vα) and the β-axis target voltage value (Vβ) to the U-phase target voltage value (Vu), the V-phase target voltage value (Vv), and the W-phase target voltage value (Vw) while the motor angle sensor value θ is within a certain range of electrical angles (hereinafter, referred to as “specific electrical angle”). The specific electrical angle corresponds to a range of the electrical angle that brings the circuit breaker 70 of the failure phase into the conduction state in one cycle of the electrical angle, and differs for each failure phase as described later.

For example, in the case where the short-circuit failure is generated in the power semiconductor element 32 of the U-phase upper arm and the power semiconductor element 32 of the U-phase lower arm is controlled to the off-state, or in the case where the open failure is generated in the power semiconductor element 32 of the U-phase lower arm and the power semiconductor element 32 of the U-phase upper arm is controlled to the on-state, if the voltage of the DC power supply 210 is Vdc, the voltage output from the U-phase upper and lower arm circuits is fixed at ½·Vdc. In addition, for example, in the case where the short-circuit failure is generated in the power semiconductor element 32 of the U-phase lower arm and the power semiconductor element 32 of the U-phase upper arm is controlled to the off-state, or in the case where the open failure is generated in the power semiconductor element 32 of the U-phase upper arm and the power semiconductor element 32 of the U-phase lower arm is controlled to the on-state, the voltage output from the U-phase upper and lower arm circuits is fixed at −½·Vdc. For this reason, even when the U-phase, V-phase, and W-phase target voltages are converted as usual, the power conversion circuit 30 cannot output the voltage according to the target voltage. For this reason, the target voltages of the remaining two phases is required to be calculated in consideration of the difference between the output voltages of the failure phases such that voltages corresponding to the α-axis target voltage value (Vα) and the β-axis target voltage value (Vβ) that are the same as those before the generation of the failure can be output even after the generation of the failure.

In the case where the short-circuit failure is generated in the U-phase power semiconductor element 32, the target voltage values of the V-phase and the W-phase are calculated by [Mathematical Formula 4]. At this point, when the voltage of the DC power supply 210 is Vdc, in the case where the short-circuit failure is generated in the power semiconductor element 32 of the U-phase upper arm and the power semiconductor element 32 of the U-phase lower arm is controlled to the off-state, or in the case where the open failure is generated in the power semiconductor element 32 of the U-phase lower arm and the power semiconductor element 32 of the U-phase upper arm is controlled to the on-state, the value of the U-phase target voltage value (Vu) is set to ½·Vdc. In addition, in the case where the short-circuit failure is generated in the power semiconductor element 32 of the U-phase lower arm and the power semiconductor element 32 of the U-phase upper arm is controlled to the off-state, or in the case where the open failure is generated in the power semiconductor element 32 of the U-phase upper arm and the power semiconductor element 32 of the U-phase lower arm is controlled to the on-state, the value of the U-phase target voltage value (Vu) is set to −½·Vdc.

$$\begin{matrix}{V}_{v} = - \sqrt{\frac{3}{2}} {V}_{α} + \frac{1}{\sqrt{2}} {V}_{β} + {V}_{u} \\ {V}_{w} = - \sqrt{\frac{3}{2}} {V}_{α} - \frac{1}{\sqrt{2}} {V}_{β} + {V}_{u}\end{matrix} \qquad [ Mathematical Formula 4 ]$$

In the case where the short-circuit failure is generated in the V-phase power semiconductor element 32, the target voltage values of the U-phase and the W-phase are calculated by [Mathematical Formula 5]. At this point, when the voltage of the DC power supply 210 is Vdc, in the case where the short-circuit failure is generated in the power semiconductor element 32 of the V-phase upper arm and the power semiconductor element 32 of the V-phase lower arm is controlled to the off-state, or in the case where the open failure is generated in the power semiconductor element 32 of the V-phase lower arm and the power semiconductor element 32 of the V-phase upper arm is controlled to the on-state, the value of the V-phase target voltage value (Vv) is set to ½·Vdc similarly to the time of the U-phase failure. In addition, in the case where the short-circuit failure is generated in the power semiconductor element 32 of the V-phase lower arm and the power semiconductor element 32 of the V-phase upper arm is controlled to the off-state, or in the case where the open failure is generated in the power semiconductor element 32 of the V-phase upper arm and the power semiconductor element 32 of the V-phase lower arm is controlled to the on-state, the value of the V-phase target voltage value (Vv) is set to −½·Vdc.

$$\begin{matrix}{V}_{u} = \sqrt{\frac{3}{2}} {V}_{α} - \frac{1}{\sqrt{2}} {V}_{β} + {V}_{u} \\ {V}_{w} = - \sqrt{2} {V}_{β} + {V}_{v}\end{matrix} \qquad [ Mathematical Formula 5 ]$$

In the case where the short-circuit failure is generated in the W-phase power semiconductor element 32, the target voltage values of the U phase and the V phase are calculated by [Mathematical Formula 6]. At this point, when the voltage of the DC power supply 210 is Vdc, in the case where the short-circuit failure is generated in the power semiconductor element 32 of the W-phase upper arm and the power semiconductor element 32 of the W-phase lower arm is controlled to the off-state, or in the case where the open failure is generated in the power semiconductor element 32 of the W-phase lower arm and the power semiconductor element 32 of the W-phase upper arm is controlled to the on-state, the value of the W-phase target voltage value (Vw) is set to ½·Vdc similarly to the time of the U-phase failure or the V-phase failure. In addition, in the case where the short-circuit failure is generated in the power semiconductor element 32 of the W-phase lower arm and the power semiconductor element 32 of the W-phase upper arm is controlled to the off-state, or in the case where the open failure is generated in the power semiconductor element 32 of the W-phase upper arm and the power semiconductor element 32 of the W-phase lower arm is controlled to the on-state, the value of the W-phase target voltage value (Vw) is set to −½·Vdc.

$$\begin{matrix}{V}_{u} = \sqrt{\frac{3}{2}} {V}_{α} + \frac{1}{\sqrt{2}} {V}_{β} + {V}_{u} \\ {V}_{v} = \sqrt{2} {V}_{β} + {V}_{v}\end{matrix} \qquad [ Mathematical Formula 6 ]$$

As described above, after setting the corrected target voltage value of each phase at the specific electrical angle, the failure-time current controller 15 calculates the duty value 15a of each phase from the set target voltage value of each phase and the voltage sensor value 40a similarly to the normal-time current controller 13.

Furthermore, the failure-time current controller 15 generates the circuit breaker switching signal 15b based on the angle sensor value θ separately from the calculation of the duty value 15a, and outputs the generated circuit breaker switching signal 15b to the circuit breaker controller 17. At this time, the failure-time current controller 15 generates the circuit breaker switching signal 15b that brings the circuit breaker 70 of the failure phase into the conduction state only during the specific electrical angle and brings the circuit breakers 70 of the two phases other than the failure phase into the conduction state at all times.

The circuit breaker controller 17 generates the circuit breaker control signal 17a based on the circuit breaker switching signal 15b output from the failure-time current controller 15. At this time, the circuit breaker control signal 17a is changed such that the circuit breaker 70 of the failure phase is in the conduction state only during the specific electrical angle and is in the cutoff state at other electrical angles and such that the circuit breaker 70 of the two phases other than the failure phase is always in the conduction state.

In the first embodiment, the failure-time current controller 15 generates the circuit breaker switching signal 15b based on the angle sensor value θ, and the circuit breaker controller 17 performs switching control of the circuit breaker 70 by changing the circuit breaker control signal 17a based on the circuit breaker switching signal 15b. However, the circuit breaker controller 17 may determine whether the current electrical angle is the specific electrical angle based on the angle sensor value θ, and control the conduction or cutoff state of the circuit breaker 70 of the failure phase according to the determination result.

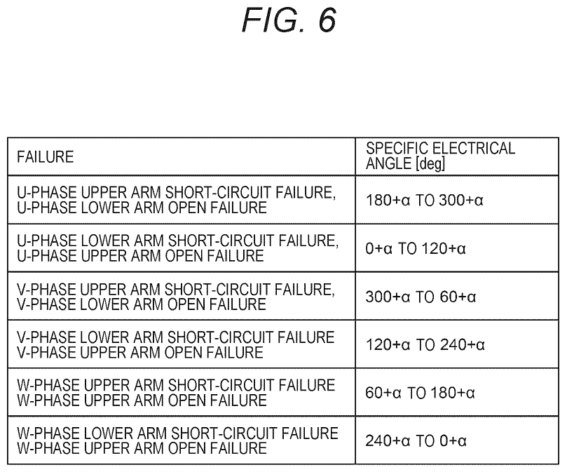

FIG. 6 is a view illustrating an example of the specific electrical angle at which the circuit breaker 70 of the failure phase is brought into the conduction state. In the current control at the time of the one-phase failure, the failure-time current controller 15 corrects the target voltage, and the specific electrical angle that brings the circuit breaker 70 of the failure phase into the conduction state is determined according to the failure phase, for example, as illustrated in FIG. 6. In each failure situation illustrated in FIG. 6, the d-axis target voltage value and the q-axis target voltage value that are the same as those in the normal state can be output from the power conversion circuit 30 by performing the current control at the time of the one-phase failure as described above in the range of each specific electrical angle. α in FIG. 6 is a variable, and changes depending on the values of the d-axis target voltage and the q-axis target voltage.

In the first embodiment, the specific electrical angle at which the current control at the time of the one-phase failure is performed is set to be in the range of 120° in terms of the electrical angle for each failure phase as illustrated in FIG. 6. However, for example, the current control at the time of the one-phase failure may be performed in the range of the electrical angle narrower than the specific electrical angle, or conversely, the current control at the time of the one-phase failure may be performed in the range of the electrical angle wider than the specific electrical angle. However, the narrower the range of the electrical angle to which the current control at the time of the one-phase failure is applied, the smaller the effect of improving the output torque. On the other hand, as the range of the electrical angle to which the current control at the time of the one-phase failure is applied becomes wider, stability at the time of control is impaired. For this reason, it is preferable to determine the range of the potential angle that performs the current control at the time of the one-phase failure in consideration of the balance.

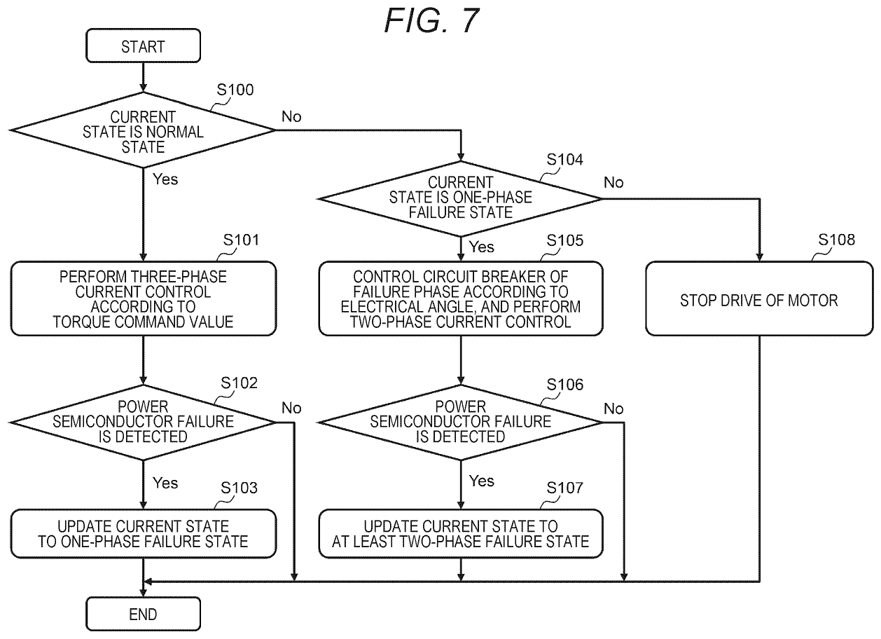

FIG. 7 illustrates an example of a control flowchart according to the first embodiment of the present invention. In the first embodiment, the control circuit 10 in FIG. 2 periodically performs the control illustrated in the flowchart of FIG. 7 at regular intervals.

First, in the processing of step S100, the control circuit 10 determines whether the internal state 19a output from the state determination unit 19 is the “normal state”. The processing proceeds to step S101 in the case where the internal state 19a is the “normal state”, and the processing proceeds to step S104 in the case where the internal state is other than the “normal state”.

In the processing of step S101, the control circuit 10 performs the current control in the normal state according to a torque command value. More specifically, as described above, the target current calculation unit 12 generates the target current value 12a according to the target torque T*, and the normal-time current controller 13 generates the duty value 13a of each phase according to the target current value 12a. Then, the PWM signal generator 16 generates the PWM signal 16a based on the duty value 13a of each phase, and outputs the PWM signal 16a to the driver circuit 20. At this time, the circuit breaker controller 17 outputs the circuit breaker control signal 17a such that the circuit breakers 70 of the three phases are always in the conduction state.

Subsequently, in the processing of step S102, the power semiconductor failure portion determination unit 18 determines whether the generation of the open failure or the short-circuit failure is detected in any one of the power semiconductor elements 32 based on the AC current sensor value 50a of each phase output from the AC current sensor 50 and the short-circuit failure detection signal 20b output from the driver circuit 20. In the case where the open failure or the short-circuit failure is detected, the failure portion is determined as described above using the AC current sensor value 50a and the PWM signal 16a, the power semiconductor failure information 18a is output based on the determination result, and then the processing proceeds to step S103.

In the processing of step S103, the state determination unit 19 determines that the current state of the power conversion device 100 is the “one-phase failure state” and updates the internal state 19a. After executing the processing of step S103, the control circuit 10 ends the control flowchart of FIG. 7.

On the other hand, in the case where no failure is detected for any of the power semiconductor elements 32 in step S102, the control circuit 10 does not execute the processing of step S103 and ends the control flowchart of FIG. 7. In this case, the power semiconductor failure portion determination unit 18 does not output the power semiconductor failure information 18a, and the state determination unit 19 maintains the internal state 19a in the “normal state”.

In the case where it is determined in step S100 that the internal state 19a output from the state determination unit 19 is not the “normal state”, the control circuit 10 determines whether the internal state 19a is the “one-phase failure state” in the processing of step S104. The processing proceeds to step 105 in the case where the internal state 19a is the “one-phase failure state”, and the processing proceeds to step 108 in the case where the internal state 19a is other than the “one-phase failure state”.

In the processing of step S105, the control circuit 10 performs the current control at the time of the one-phase failure according to the torque command value. More specifically, as described above, the target current calculation unit 12 generates the target current value 12a according to the target torque T*, and the failure-time current controller 15 generates the duty value 15a of each phase according to the target current value 12a. Then, the PWM signal generator 16 generates the PWM signal 16a based on the duty value 15a of each phase, and outputs the PWM signal 16a to the driver circuit 20. Thus, driving of another power semiconductor element 32 different from the power semiconductor element 32 determined to be the failure portion by the power semiconductor failure portion determination unit 18 is controlled.

In addition, the failure-time current controller 15 generates the circuit breaker switching signal 15b such that the circuit breaker 70 other than the failure phase is always brought into the conduction state and such that the circuit breaker 70 of the failure phase is brought into the conduction state only during the specific electrical angle, and outputs the circuit breaker switching signal 15b to the circuit breaker controller 17. The circuit breaker controller 17 outputs the circuit breaker control signal 17a based on the circuit breaker switching signal 15b output from the failure-time current controller 15. Thus, the circuit breaker 70 of the phase corresponding to the power semiconductor element 32 determined to be the failure portion by the power semiconductor failure portion determination unit 18 is controlled such that the AC current generated by the power semiconductor element 32 of the failure phase is conducted in a predetermined conduction period corresponding to the specific electrical angle in one cycle of the electrical angle of the motor 190 and such that the AC current is cut off in other periods.

Subsequently, in the processing of step S106, the power semiconductor failure portion determination unit 18 determines whether the generation of the open failure or the short-circuit failure is detected for any of the power semiconductor elements 32 in the phase different from the phase in which the failure is already detected. In the case where the generation of the open failure or the short-circuit failure is detected, the power semiconductor failure information 18a is updated and output, and the processing proceeds to step S107.

In the processing of step S107, the state determination unit 19 determines that the current state of the power conversion device 100 is the “failure state of at least two phases” and updates the internal state 19a. After executing the processing of step S107, the control circuit 10 ends the control flowchart of FIG. 7.

On the other hand, in the case where no failure is detected in the power semiconductor element 32 of the phase different from the failure phase in step S106, the control circuit 10 does not execute the processing of step S107 and ends the control flowchart of FIG. 7. In this case, the state determination unit 19 maintains the internal state 19a in the “one-phase failure state”.

In the case where it is determined in step S104 that the internal state 19a output from the state determination unit 19 is not the “one-phase failure state”, namely, in the case where the internal state 19a is the “at least two-phase failure state”, the control circuit 10 performs control to stop the drive of the motor 190 in the processing of step S108. For example, the PWM signal generator 16 outputs the PWM signal 16a to the driver circuit 20 such that the power conversion circuit 30 is in the free wheel state, or the circuit breaker controller 17 outputs the circuit breaker control signal 17a to the circuit breaker drive circuit 60 such that all the circuit breakers 70 are in the cutoff state. Alternatively, both are performed. Thus, the driving of the motor 190 is stopped.

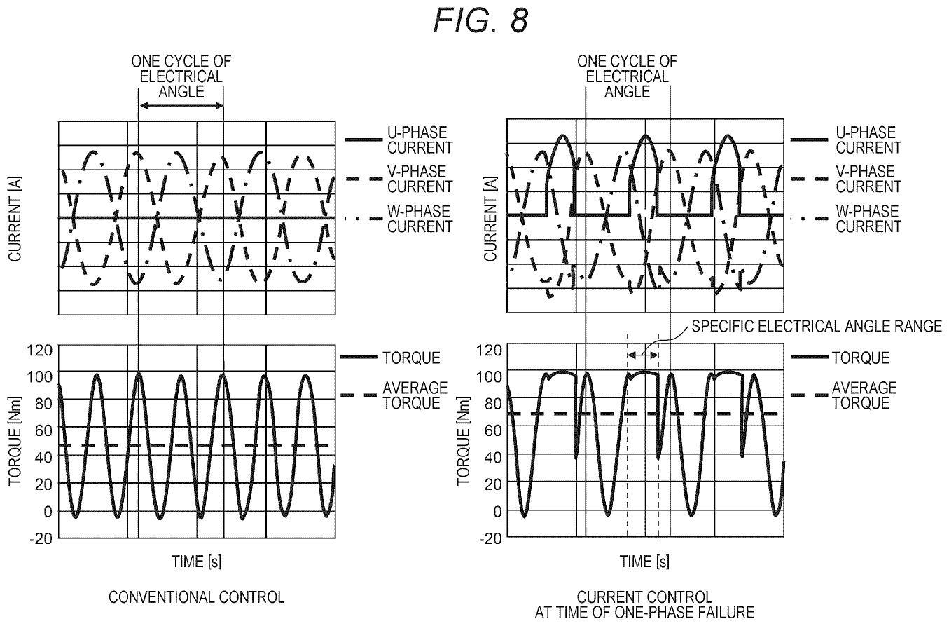

FIG. 8 is a view illustrating an example of output torque at the time of the one-phase failure according to the first embodiment of the present invention. In this example, it is assumed that the target torque T* is set to 100 [Nm] and the short-circuit failure is generated in the power semiconductor element 32 of the U-phase upper arm. In FIG. 8, the graph on the left side illustrates waveform examples of each phase current and torque in the case where the U-phase circuit breaker 70 of the failure phase is cut off to continue the motor drive only in two normal phases (V-phase, W-phase) based on the same target voltage as that in the normal time (conventional control). In addition, the graph on the right side illustrates waveform examples of each phase current and torque in the case where the current control at the time of the one-phase failure described in the first embodiment is applied.

In the conventional control illustrated in the left graph, because the circuit breaker 70 of the U-phase is in the cutoff state, no current flows in the U-phase, and the torque is controlled using only the normal V-phase and W-phase currents. In this state, the output torque changes sinusoidally between the target torque and 0 [Nm], and the average torque becomes about 50% of the target torque. In order to improve the average torque in this state, the target torque is required to be made larger than that at the normal time, and the amount of torque fluctuation further increases at that time.

On the other hand, in the first embodiment, when the current control at the time of the one-phase failure is applied, the circuit breaker 70 of the U-phase is conducted between the specific electrical angles as described above, and the current also flows in the U-phase. Thus, as illustrated in the graph on the right side, because the output torque close to the target torque can be obtained during the specific electrical angle, the average torque can be improved. Because the output torque during the application of this control fluctuates between the target torque and 0 [Nm], a torque fluctuation amount can be maintained at a value similar to that of the conventional control.

As described above, according to the power conversion device 100 of the first embodiment, when the current control at the time of the one-phase failure is applied, the average torque can be improved while the torque fluctuation amount equivalent to the conventional torque fluctuation amount is maintained. For this reason, deterioration of ride comfort can be prevented while acceleration capability of the vehicle 1 is maintained to some extent even after the failure.

The current control at the time of the one-phase failure according to the first embodiment can obtain the effect of improving the average torque not only in the conventional control in which the control is performed at the same target voltage as that at the time of the normal state even at the time of the failure but also in comparison with the control method described in PTL 1 described above. That is, in the control of PTL 1, the output torque decreases to 0 [Nm] at two electrical angles in one cycle of the electrical angle, but when the current control at the time of one-phase failure according to the first embodiment is applied, the output torque at one electrical angle can be improved to the same level as the target torque as illustrated in the graph on the right side of FIG. 8. For this reason, the average torque can be improved as compared with the control of PTL 1.

According to the first embodiment of the present invention described above, the following operational effects are achieved.

(1) The power conversion device 100 includes the power conversion circuit 30, the circuit breaker 70, and the control circuit 10 that functions as the power semiconductor failure portion determination unit 18, the circuit breaker controller 17, and the failure-time current controller 15. In the power conversion circuit 30, the upper and lower arm circuits in which the power semiconductor elements 32 as the switching elements are connected in series are connected in parallel for at least three phases, and the AC current generated by the power semiconductor elements 32 of each phase is output to the motor 190 through the output line. The circuit breaker 70 is provided on the output line of each phase to conduct or cut off the AC current. The power semiconductor failure portion determination unit 18 determines the failure portion of the power semiconductor element 32. The circuit breaker controller 17 controls the circuit breaker 70 of the failure phase such that the AC current of the failure phase is conducted at a predetermined specific electrical angle in one cycle of the electrical angle and such that the AC current of the failure phase is cut off at other electrical angles except for the specific electrical angle, with the phase corresponding to the power semiconductor element 32 determined as the failure portion by the power semiconductor failure portion determination unit 18 as the failure phase. The failure-time current controller 15 controls the driving of another power semiconductor element 32 different from the power semiconductor element 32 determined to be the failure portion. With this configuration, even after the failure of the power semiconductor element 32, the driving of the motor 190 can be continued while the torque fluctuation is prevented.

(2) The specific electrical angle has the range of 1200 in the electrical angle. With this configuration, even when any of the power semiconductor elements 32 fails, the driving of the motor 190 that is the three-phase AC motor can be reliably continued.

(3) The circuit breaker controller 17 changes the specific electrical angle for each failure phase. With this configuration, even when the power semiconductor element 32 fails in any phase, the driving of the motor 190 can be reliably continued.

### Second Embodiment

An example of a power conversion device and a drive device that improve the average output torque while maintaining the torque fluctuation even after the failure of the power semiconductor and make it easy to start the vehicle in the case where the switching of the circuit breaker is delayed will be described in a second embodiment.

The power conversion device 100 and the drive device 200 in the second embodiment have the same configurations as those in FIG. 2 described in the first embodiment. For this reason, the power conversion device 100 and the drive device 200 of the second embodiment will be described below with reference to the configuration of FIG. 2.

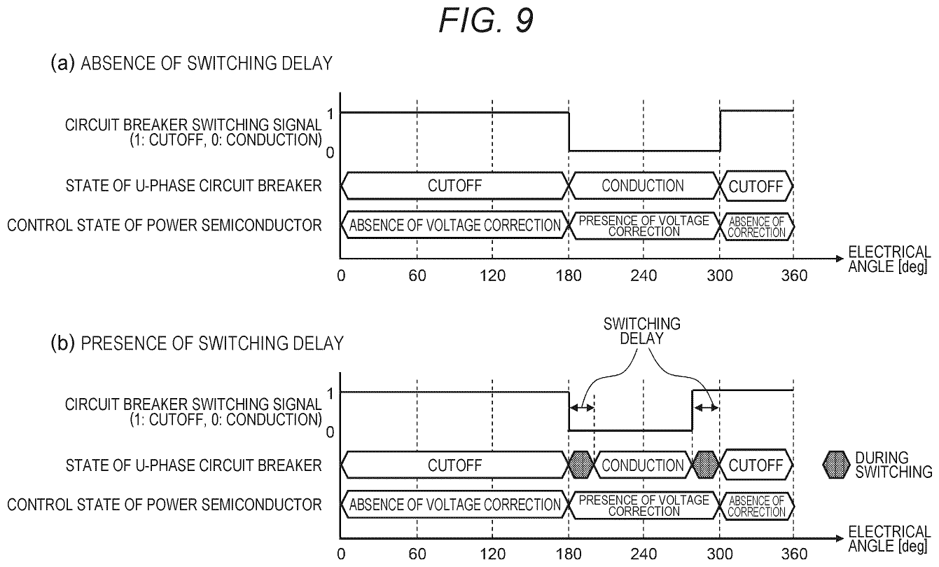

FIG. 9 is an explanatory diagram illustrating switching timing of the circuit breaker 70 according to the second embodiment of the present invention. In FIG. 9, (a) illustrates an example of a timing chart in the case where there is no switching delay of the circuit breaker 70, and (b) illustrates an example of a timing chart in the case where there is the switching delay of the circuit breaker 70. In both of FIGS. 9(a) and 9(b), it is assumed that the short-circuit failure is generated in the power semiconductor element 32 of the U-phase upper arm. In addition, it is assumed that the variable a of the specific electrical angle in FIG. 6 described above is zero. FIG. 9(a) corresponds to the switching timing of the circuit breaker 70 by the current control at the time of the one-phase failure described in the first embodiment, and FIG. 9(b) corresponds to the switching timing of the circuit breaker 70 by the current control at the time of the one-phase failure in the second embodiment.

In FIG. 9(a), an ideal state in which there is no switching delay of the circuit breaker 70 is assumed. For this reason, at the start timing of the specific electrical angle (180 to 300 [deg]), the circuit breaker controller 17 switches the circuit breaker 70 of the U-phase from the cutoff state to the conduction state according to the change in the circuit breaker switching signal 15b output from the failure-time current controller 15. In addition, at the end timing of the specific electrical angle, the circuit breaker 70 of the U-phase is switched from the conduction state to the cutoff state according to the change in the circuit breaker switching signal 15b output from the failure-time current controller 15.

However, because the normal circuit breaker 70 has a switching delay time, it is actually necessary to control the switching of the circuit breaker 70 in consideration of this delay time. In the second embodiment, as illustrated in FIG. 9(b), the switching timing of the circuit breaker 70 is set in consideration of the delay time. Specifically, the timing at which the circuit breaker controller 17 switches the circuit breaker 70 from the cutoff state to the conduction state is the same as in the case of FIG. 9(a) in which the switching is not delayed, but the timing at which the circuit breaker 70 is switched from the conduction state to the cutoff state is advanced from the end timing of the specific electrical angle by the switching delay time of the circuit breaker 70. The switching timing of the circuit breaker 70 may be advanced by changing the timing of the circuit breaker switching signal 15b in the failure-time current controller 15, or may be advanced by changing the timing of the circuit breaker switching signal 15b in the circuit breaker controller 17 without changing the timing of the circuit breaker switching signal 15b.

When the circuit breaker 70 is brought into the conduction state, the output voltage of the failure phase becomes ½·Vdc or −½·Vdc as described above. In the current control at the time of the one-phase failure described in the first embodiment, the d-axis target voltage value and the q-axis target voltage value that are the same as those in the normal state can be output from the power conversion circuit 30 by correcting the normal two-phase output voltages within the range of the specific electrical angle. However, in other ranges, the corrected normal two-phase voltage becomes too large to be corrected. Because the current control becomes unstable in this state, it is desirable not to bring the circuit breaker 70 of the failure phase into the conduction state in the range other than the specific electrical angle. Accordingly, in the second embodiment, the timing at which the circuit breaker controller 17 instructs the circuit breaker 70 to switch from the conduction state to the cutoff state is advanced by the switching delay time of the circuit breaker 70, thereby preventing the circuit breaker 70 of the failure phase from becoming the conduction state in the range other than the specific electrical angle. Thus, even when there is the switching delay of the circuit breaker 70, the current control can be stabilized.

According to the second embodiment of the present invention described above, the circuit breaker controller 17 instructs the circuit breaker 70 of the failure phase to switch from the conduction state to the cutoff state before the end timing of the specific electrical angle. With this configuration, the circuit breaker 70 of the failure phase can be prevented from being brought into the conduction state in the range other than the specific electrical angle to stabilize the current control at the time of the one-phase failure.

### Third Embodiment

An example of a power conversion device and a drive device that reduce a processing load of a control circuit, improve the average output torque while maintaining the torque fluctuation even after the failure of the power semiconductor, and make it easy to start the vehicle in the case where the switching of the circuit breaker is delayed will be described in a third embodiment.

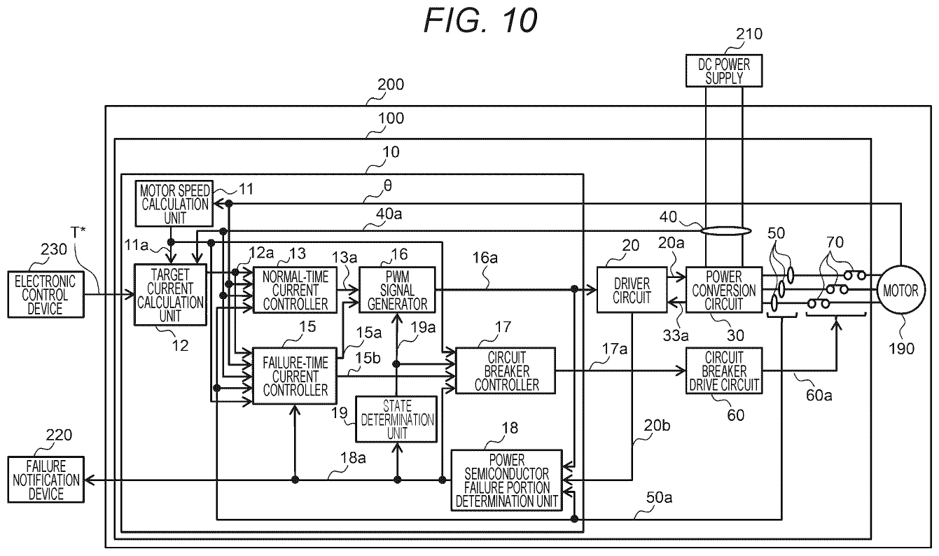

FIG. 10 is a view illustrating a configuration example of the power conversion device 100 and the drive device 200 according to the third embodiment of the present invention. The power conversion device 100 in the third embodiment has the same configuration as that of FIG. 2 described in the first embodiment, and is different in that the motor speed value 11a calculated by the motor speed calculation unit 11 is further output to the failure-time current controller 15 and the circuit breaker controller 17 in addition to the target current calculation unit 12. Hereinafter, the description of portions common to the first and second embodiments will be omitted.

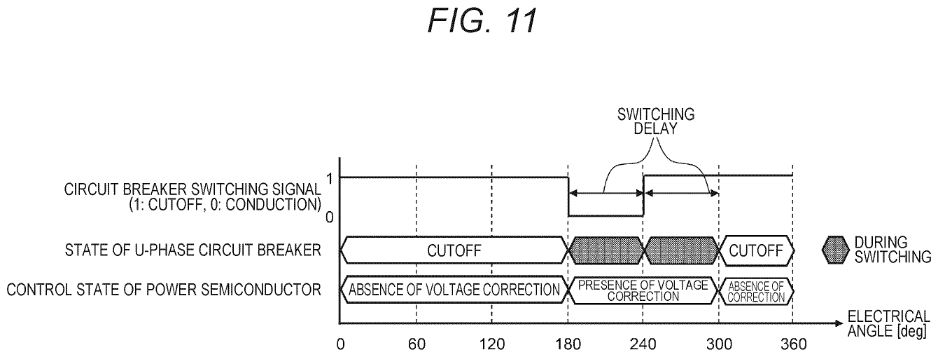

FIG. 11 is an explanatory diagram illustrating the switching timing of the circuit breaker 70 according to the third embodiment of the present invention. In the second embodiment described above, the switching control in a case where the switching of the circuit breaker 70 is delayed has been described. However, as illustrated in FIG. 11, when the delay time of the circuit breaker 70 becomes equal to or longer than the electrical angle corresponding to 60 [deg], in this control method, the time for the circuit breaker 70 of the failure phase to be in the conduction state is eliminated, and the effect of the current control at the time of the one-phase failure cannot be obtained. That is, because a ratio of the electrical angle occupied by the delay time of the circuit breaker 70 in one cycle of the electrical angle increases as the motor rotation speed increases, the effect of the current control at the time of the one-phase failure cannot be obtained in a situation where the motor rotation speed is fast.

Accordingly, in the third embodiment, at the motor rotational speed at which the delay time of the circuit breaker 70 is equal to or longer than the electrical angle corresponding to 60 [deg], the control circuit 10 does not perform the current control at the time of the one-phase failure but controls the circuit breaker 70 to be always in the cutoff state. Thus, unnecessary switching of the circuit breaker 70 is eliminated, and the processing load of the control circuit 10 in the power conversion device 100 is reduced.

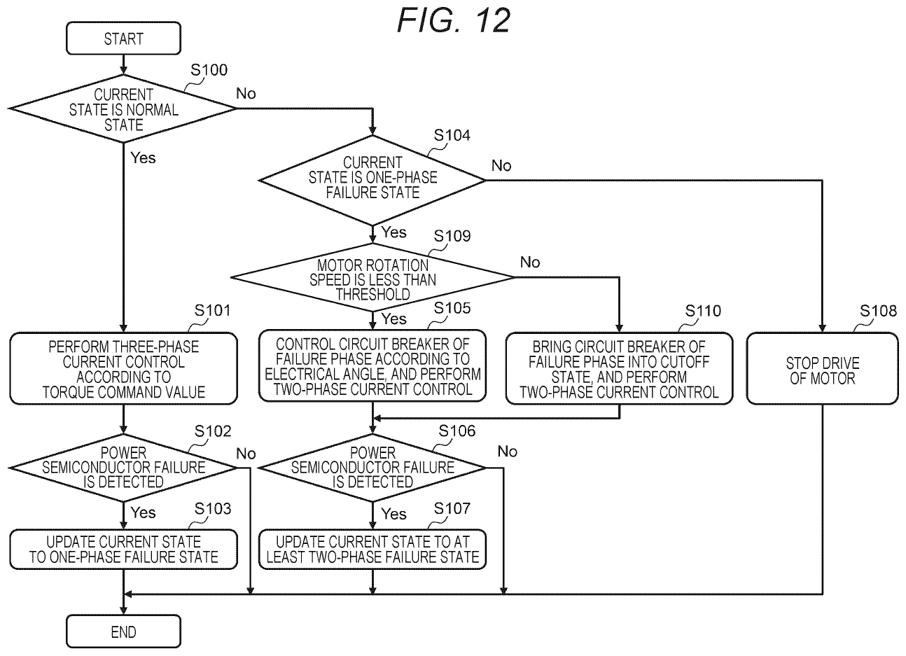

FIG. 12 illustrates an example of the control flowchart according to the third embodiment of the present invention. In the third embodiment, the control circuit 10 in FIG. 10 periodically performs the control illustrated in the flowchart of FIG. 12 at regular intervals. In FIG. 12, portions performing the same pieces of processing as those in the control flowchart of FIG. 7 described in the first embodiment are denoted by the same symbols as those in FIG. 7, and description of those pieces of processing is omitted.

In the third embodiment, in the processing of step S104, the processing proceeds to step S109 in the case where the internal state 19a is the “one-phase failure state”, and the processing proceeds to step S108 in the case where the internal state 19a is other than the “one-phase failure state”.

In the processing of step S109, the control circuit 10 determines whether the motor rotational speed (rotation speed) is less than a predetermined threshold based on the motor speed value 11a calculated by the motor speed calculation unit 11. The processing proceeds to step S105 in the case where the motor rotational speed is less than the threshold, and the processing proceeds to step S110 in the case where the motor rotational speed is equal to or greater than the threshold.

In the processing of step S110, the control circuit 10 performs conventional failure-time control. Specifically, the circuit breaker 70 of the failure phase is controlled so as to be in the cutoff state at all times, and the normal two-phase power semiconductor elements 32 other than the failure phase are controlled in the same manner as in the normal state. Thereafter, the processing proceeds to step S106.

As described above, according to the power conversion device 100 of the third embodiment, the current control at the time of the one-phase failure is applied in the case where the motor rotational speed is less than the predetermined threshold. However, the current control at the time of the one-phase failure is not applied in the case where the motor rotational speed is equal to or greater than the threshold, but the current control similar to the conventional current control in which the failure phase is not energized is performed. Thus, unnecessary switching control of the circuit breaker 70 can be eliminated, and the processing load of the control circuit 10 can be reduced.

According to the third embodiment of the present invention described above, when the rotation speed of the motor 190 is equal to or greater than the predetermined threshold (No in step S109), the circuit breaker controller 17 controls the circuit breaker 70 of the failure phase such that the AC current is cut off in the entire period of one cycle of the electrical angle (step S110). On the other hand, in the case where the rotation speed of the motor 190 is less than the threshold (Yes step S109), the circuit breaker 70 of the failure phase is controlled such that the AC current of the failure phase is conducted at the specific electrical angle and the AC current of the failure phase is cut off at other electrical angles except the specific electrical angle (step S105). With this configuration, the current control at the time of the one-phase failure can be performed while the processing load of the control circuit 10 is reduced.

### Fourth Embodiment

An example of a power conversion device and a drive device that improve the average output torque while maintaining the torque fluctuation even after the failure of the power semiconductor by a method different from the second and third embodiments and make it easy to start the vehicle in the case where the switching of the circuit breaker is delayed will be described in a fourth embodiment.

The power conversion device 100 and the drive device 200 in the second embodiment have the same configurations as those in FIG. 2 described in the first embodiment. For this reason, the power conversion device 100 and the drive device 200 of the second embodiment will be described below with reference to the configuration of FIG. 2.

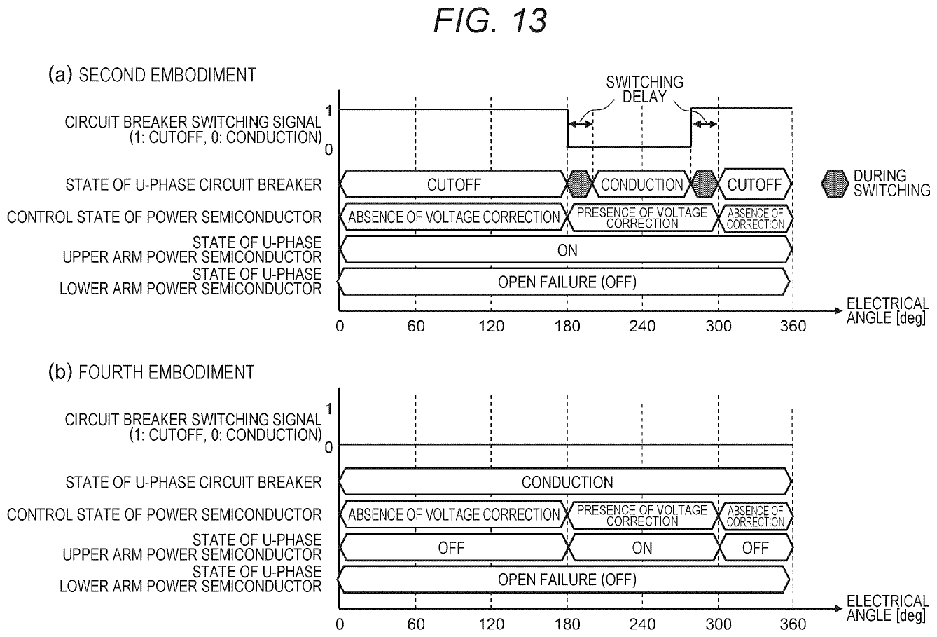

FIG. 13 is an explanatory diagram illustrating the switching timing of the circuit breaker 70 according to the fourth embodiment of the present invention. In FIG. 13, (a) illustrates an example of a timing chart in the case where the circuit breaker switching and the current control described in the second embodiment are performed, and (b) illustrates an example of a timing chart in the case where the circuit breaker switching and the current control according to the fourth embodiment are performed. In both of FIGS. 13(a) and 13 (b), it is assumed that the open failure is generated in the power semiconductor element 32 of the U-phase upper arm.

In the first and second embodiments, even when the power semiconductor element 32 has the open failure or the short-circuit failure, in the current control at the time of the one-phase failure, one of the upper and lower arms of the failure phase is controlled such that the power semiconductor element 32 is always turned on and the other is always turned off, and the circuit breaker 70 of the failure phase is controlled so as to be in the conduction state only during the specific electrical angle. For this reason, for example, in the second embodiment, in the case where the open failure is generated in the power semiconductor element 32 of the U-phase lower arm, as illustrated in FIG. 13(a), the power semiconductor element 32 of the U-phase upper arm is always turned on, and the circuit breaker 70 of the U-phase is controlled to be in the conduction state in the period shorter than the specific electrical angle by the switching delay time of the circuit breaker 70.

However, in the case where the open failure is generated in any one of the power semiconductor elements 32 of the upper and lower arms, the output voltage control similar to the current control at the time of the one-phase failure described in the first and second embodiments can be implemented in the power conversion device 100 not by controlling the cutoff or conduction of the circuit breaker 70 but by controlling the on- or off-states of the power semiconductor elements 32 on the upper and lower opposite sides in phase with the failure portion. Accordingly, in the fourth embodiment, in the case where the open failure of the power semiconductor element 32 is generated, as the current control at the time of the one-phase failure, the circuit breaker 70 of the failure phase is controlled to be always in the conduction state, and the power semiconductor element 32 on the upper and lower opposite sides in phase with the failure portion is controlled to be in the on-state only for the specific electrical angle.

Specifically, for example, as in the timing chart of FIG. 13(b), the circuit breaker 70 of the failure phase (U-phase) is always brought into the conduction state, and the power semiconductor element 32 on the upper and lower opposite sides (U-phase upper arm) in the same phase as the failure portion is controlled to be in the on-state only during the specific electrical angle described in the first embodiment. Thus, the current control at the time of the one-phase failure similar to that in the first and second embodiments can be implemented.

For example, as in the case where the mechanical switch is used for the circuit breaker 70, in the case where the conduction or cutoff switching delay time of the circuit breaker 70 is long and the on or off switching delay time of the power semiconductor element 32 is short compared to this, the influence of the switching delay time of the circuit breaker 70 can be reduced by performing the control of the fourth embodiment. Consequently, even in the situation where the motor rotation speed is high, the same control as the current control at the time of the one-phase failure can be applied in the power conversion device 100. For this reason, even when the vehicle 1 is traveling at a high speed, the average output torque can be improved while the torque fluctuation similar to the conventional control is maintained.

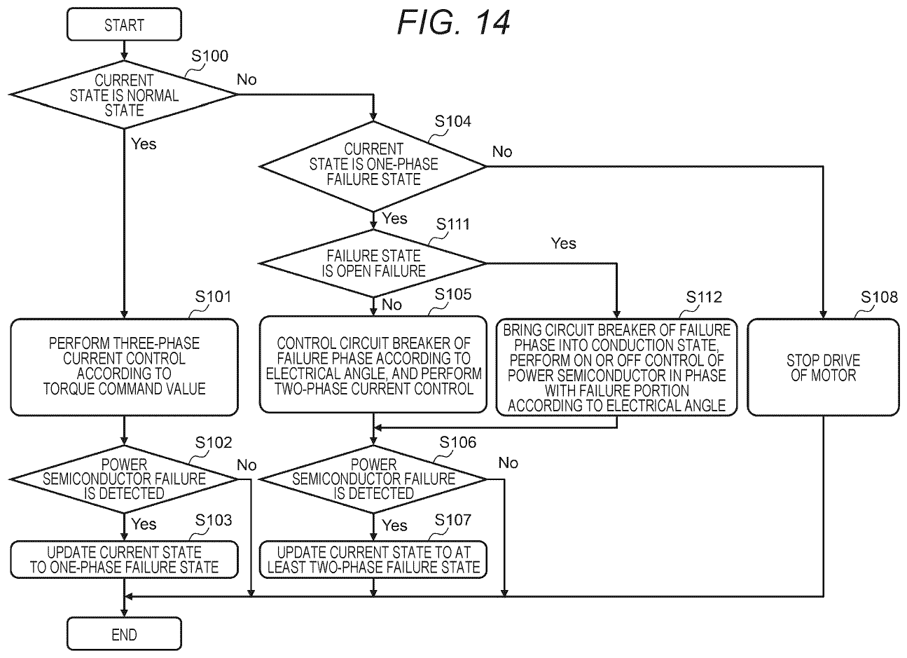

FIG. 14 illustrates an example of a control flowchart according to the fourth embodiment of the present invention. In the fourth embodiment, the control circuit 10 in FIG. 2 periodically performs the control illustrated in the flowchart of FIG. 14 at regular intervals. In FIG. 14, portions performing the same pieces of processing as those in the control flowchart of FIG. 7 described in the first embodiment are denoted by the same symbols as those in FIG. 7, and description of those pieces of processing is omitted.

In the fourth embodiment, in the processing of step S104, the processing proceeds to step S111 in the case where the internal state 19a is the “one-phase failure state”, and the processing proceeds to step S108 in the case where the internal state is other than the “one-phase failure state”.

In the processing of step S111, the control circuit 10 determines whether the failure state of the power semiconductor element 32 in which the failure is detected is the open failure. The processing proceeds to step S112 when the open failure is detected, and the processing proceeds to step S105 in the case where the short-circuit failure is detected instead of the open failure.

In the processing of step S112, the control circuit 10 controls the circuit breaker 70 of the failure phase to be always in the conduction state, and controls the power semiconductor elements 32 on the upper and lower opposite sides in phase with the failure portion to be in the on-state only during the specific electrical angle. Thus, the current control at the time of the one-phase failure is performed. Thereafter, the processing proceeds to step S106.

As described above, according to the power conversion device 100 of the fourth embodiment, in the case where the open failure of the power semiconductor element 32 is generated, the circuit breaker 70 of the failure phase is controlled so as to be always in the conduction state, and the power semiconductor element 32 on the upper and lower opposite sides in phase with the failure portion is controlled so as to be in the on-state only for the specific electrical angle. Thus, the influence of the switching delay time of the circuit breaker 70 can be eliminated and the current control at the time of the one-phase failure can be performed.

According to the fourth embodiment of the present invention described above, in the case where the open failure is generated in the power semiconductor element 32 (Yes in step S111), the circuit breaker controller 17 brings the circuit breaker 70 of the failure phase into the conduction state, and the failure-time current controller 15 controls the drive of the power semiconductor element 32 of the phase different from the failure phase and the power semiconductor element 32 that is not the power semiconductor element 32 determined to be the failure portion in the upper and lower arm circuits in the failure phase (step S112). With this configuration, the influence of the switching delay time of the conduction or cutoff of the circuit breaker 70 can be reduced, and the same control as the current control at the time of the one-phase failure can be implemented even in the situation where the motor rotation speed is high.

### Fifth Embodiment

An example of a power conversion device and a drive device capable of coping with the failure of the circuit breaker, improving the average output torque, and maintaining the torque fluctuation even after the failure of the power semiconductor will be described in a fifth embodiment.

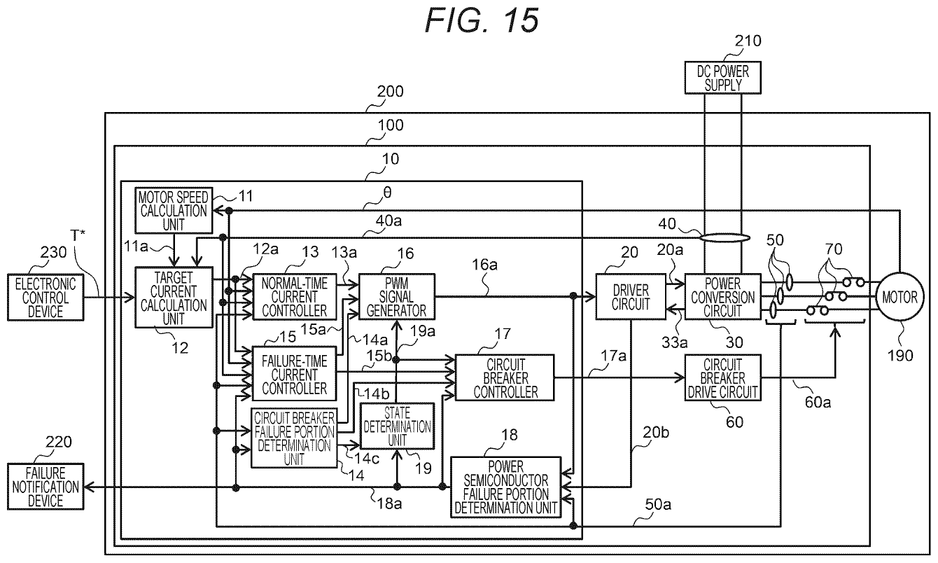

FIG. 15 is a view illustrating a configuration example of the power conversion device 100 and the drive device 200 according to the fifth embodiment of the present invention. In the power conversion device 100 of the fifth embodiment, the control circuit 10 further includes a circuit breaker failure portion determination unit 14 in addition to the configuration similar to that of FIG. 2 described in the first embodiment. Hereinafter, description of portions common to the first to fourth embodiments will be omitted.

When diagnosing the circuit breaker 70, the circuit breaker failure portion determination unit 14 generates a predetermined duty value 14a for each phase and outputs the duty value 14a to the PWM signal generator 16. During the diagnosis of the circuit breaker 70, a predetermined circuit breaker switching signal 14b is generated for each phase and output to the circuit breaker controller 17. The circuit breaker failure portion determination unit 14 can determine whether the circuit breaker 70 of each phase fails using the AC current sensor value 50a of each phase output from the AC current sensor 50 when these signals are output. When the diagnosis of the circuit breaker 70 is completed, the circuit breaker failure portion determination unit 14 outputs circuit breaker diagnostic information 14c indicating that the diagnosis of the circuit breaker 70 is completed to the state determination unit 19, and the failure portion when there is the failure.

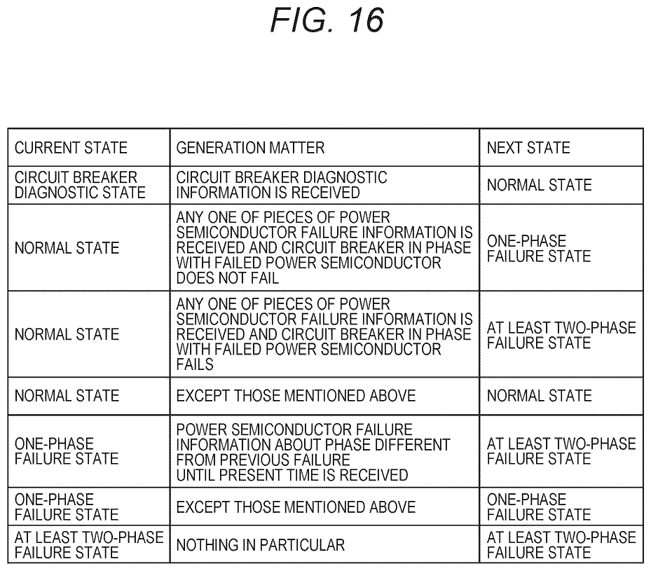

FIG. 16 is a view illustrating an example of internal state determination of the state determination unit 19 according to the fifth embodiment of the present invention. In the fifth embodiment, the initial state of the state determination unit 19 is a “circuit breaker diagnostic state”. When the state determination unit 19 receives the circuit breaker diagnostic information 14c from the circuit breaker failure portion determination unit 14 while the current state is the “circuit breaker diagnostic state”, the next state is changed to the “normal state”.

When receiving the power semiconductor failure information 18a indicating that the power semiconductor element 32 of any phase fails from the power semiconductor failure portion determination unit 18 while the current state is the “normal state”, the state determination unit 19 changes the current state according to contents of the circuit breaker diagnostic information 14c received from the circuit breaker failure portion determination unit 14 so far. Specifically, in the case where the circuit breaker diagnostic information 14c indicating that the circuit breaker 70 having the same phase as the failed power semiconductor element 32 fails is received, the next state is changed to a “at least two-phase failure state”. On the other hand, in the case where the circuit breaker diagnostic information 14c indicating that the circuit breaker 70 of the phase different from that of the failed power semiconductor element 32 fails or the circuit breaker diagnostic information 14c indicating that the circuit breaker 70 does not fail is received, the next state is changed to the “one-phase failure state”. When the current state is the “normal state”, the next state remains in the “normal state” in the case other than the above.

The case where the current state is the “one-phase failure state” or the “at least two-phase failure” is similar to that of the first embodiment.

A method for diagnosing the circuit breaker 70 according to the fifth embodiment will be described below. In the case where the internal state output from the state determination unit 19 is the “circuit breaker diagnostic state”, the PWM signal generator 16 generates the PWM signal 16a of each phase according to the duty value 14a of each phase output from the circuit breaker failure portion determination unit 14. In the case where the internal state output from the state determination unit 19 is the “circuit breaker diagnostic state”, the circuit breaker controller 17 controls the conduction or cutoff states of the circuit breakers 70 of each phase according to the circuit breaker switching signal 14b output from the circuit breaker failure portion determination unit 14. The circuit breaker failure portion determination unit 14 can determine whether the circuit breaker 70 of each phase fails based on the AC current sensor value 50a of each phase output from the AC current sensor 50 when these signals are output.

The failure of the circuit breaker 70 roughly includes two types of failure states of a cutoff fixing failure in which the circuit breaker 70 does not change from the cutoff state and a conduction fixing failure in which the circuit breaker 70 does not change from the conduction state. In the case where the circuit breaker 70 has the conduction fixing failure, when the short-circuit failure is generated in the power semiconductor element 32 having the same phase as the failed circuit breaker 70, the power conversion device 100 cannot cut off the AC current flowing through the failure phase regardless of whether the circuit breaker 70 or the power semiconductor element 32 is used. Consequently, in this case, the current control at the time of the one-phase failure cannot be continued. Accordingly, in the fifth embodiment, in order to determine such a situation, the circuit breaker failure portion determination unit 14 diagnoses the presence or absence of the conduction fixing failure for the circuit breaker 70 of each phase.

When determining the presence or absence of the conduction fixing failure of the circuit breaker 70 using a certain phase as a diagnostic object phase, the circuit breaker failure portion determination unit 14 selects one phase (hereinafter, referred to as “selection phase”) different from the diagnostic object phase, and generates and outputs the circuit breaker switching signal 14b to the circuit breaker controller 17 so as to bring the circuit breaker 70 of the selection phase into the conduction state and to bring the circuit breakers 70 of the other two phases into the cutoff state. In addition, the circuit breaker failure portion determination unit 14 generates the duty value 14a such that the power semiconductor element 32 of the upper arm of the diagnostic object phase and the power semiconductor element 32 of the lower arm of the selection phase are turned on only for a predetermined short time, and outputs the duty value 14a to the PWM signal generator 16. The upper arm and the lower arm may be replaced with each other in a combination of the power semiconductor elements 32 to be turned on at this time. That is, the power semiconductor element 32 of the lower arm of the diagnostic object phase and the power semiconductor element 32 of the upper arm of the selection phase may be turned on only for the predetermined short time.

When the circuit breaker switching signal 14b and the duty value 14a as described above are output, no current flows through the diagnostic object phase in the case where the circuit breaker 70 of the diagnostic object phase is normally cut off. However, in the case where the circuit breaker 70 of the diagnostic object phase has the conduction fixing failure, a current path passing through the power semiconductor element 32 of the diagnostic object phase, the circuit breaker 70 and the motor winding, the motor winding of the selection phase, the circuit breaker 70, and the power semiconductor element 32 is formed, and the current flows through the current path. For this reason, when performing the circuit breaker diagnosis operation, the circuit breaker failure portion determination unit 14 determines whether the current of at least a certain value flows through the diagnostic object phase based on the AC current sensor value 50a. As a result, in the case where it is determined that the current flows, it is determined that the circuit breaker 70 of the diagnostic object phase is in the conduction fixing failure state.

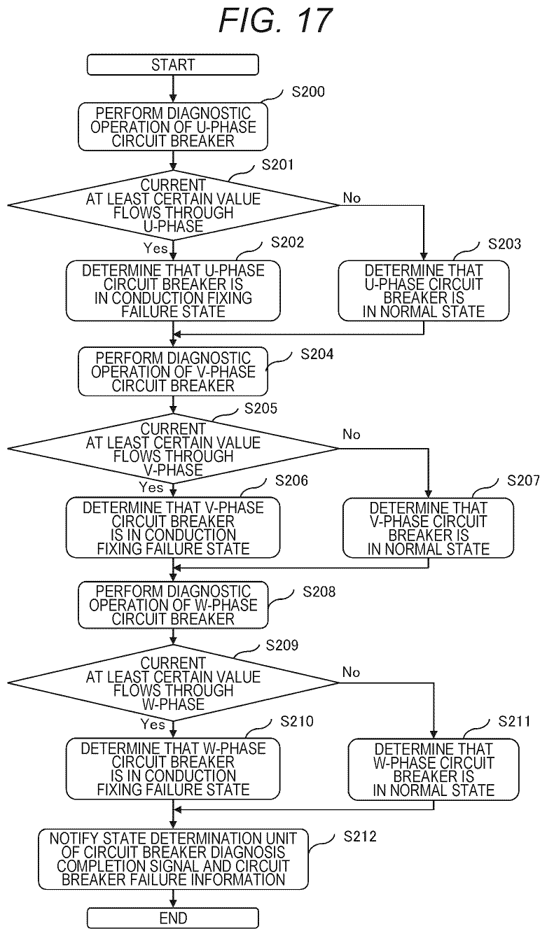

FIG. 17 illustrates an example of a flowchart of the circuit breaker diagnosis according to the fifth embodiment of the present invention. In the fifth embodiment, the circuit breaker failure portion determination unit 14 performs the control illustrated in the flowchart of FIG. 17 before the operation of the driver circuit 20 and the power conversion circuit 30.

In the processing of step S200, the circuit breaker failure portion determination unit 14 performs the diagnostic operation of the conduction fixing failure of the circuit breaker 70 of the U-phase. Specifically, as described above, with the U-phase as the diagnostic object phase and either the V-phase or the W-phase as the selection phase, the circuit breaker switching signal 14b that brings the circuit breaker 70 of the selection phase into the conduction state and brings the circuit breaker 70 of the U-phase and the circuit breaker 70 of the phase that is not the selection phase into the cutoff state is output to the circuit breaker controller 17. The duty value 14a, with which the power semiconductor element 32 of the upper arm (or lower arm) of the U-phase and the power semiconductor element 32 of the lower arm (or upper arm) of the selection phase are turned on only for the short time, is output to the PWM signal generator 16.

When the duty value 14a and the circuit breaker switching signal 14b are output from the circuit breaker failure portion determination unit 14, the PWM signal generator 16 generates the PWM signal 16a based on the duty value 14a and outputs the PWM signal to the driver circuit 20. In addition, the circuit breaker controller 17 controls the conduction or cutoff state of the circuit breaker 70 of each phase based on the circuit breaker switching signal 14b.

In the processing of step S201, the circuit breaker failure portion determination unit 14 determines whether the current at least a certain value flows in the U-phase based on the U-phase AC current sensor value 50a output from the AC current sensor 50. In the case where the current of at least the certain value flows through the U-phase, the circuit breaker failure portion determination unit 14 next performs the processing of step S202, and otherwise, the circuit breaker failure portion determination unit 14 next performs the processing of step S203.

In the processing of step S202, the circuit breaker failure portion determination unit 14 determines that the circuit breaker 70 of the U-phase has the conduction fixing failure. In the processing of step S203, the circuit breaker failure portion determination unit 14 determines that the circuit breaker 70 of the U-phase is normal. After the processing of step S202 or S203 is performed, the processing proceeds to step S204.

In the processing of step S204, the circuit breaker failure portion determination unit 14 performs the diagnostic operation of the conduction fixing failure of the V-phase circuit breaker 70. Specifically, as described above, with the V-phase as the diagnostic object phase and either the U-phase or the W-phase as the selection phase, the circuit breaker switching signal 14b that brings the circuit breaker 70 of the selection phase into the conduction state and brings the circuit breaker 70 of the V-phase and the circuit breaker 70 of the phase that is not the selection phase into the cutoff state is output to the circuit breaker controller 17. In addition, the duty value 14a with which the power semiconductor element 32 of the upper arm (or lower arm) of the V-phase and the power semiconductor element 32 of the lower arm (or upper arm) of the selection phase are turned on only for the short time is output to the PWM signal generator 16.

When the duty value 14a and the circuit breaker switching signal 14b are output from the circuit breaker failure portion determination unit 14, the PWM signal generator 16 generates the PWM signal 16a based on the duty value 14a and outputs the PWM signal to the driver circuit 20. In addition, the circuit breaker controller 17 controls the conduction or cutoff state of the circuit breaker 70 of each phase based on the circuit breaker switching signal 14b.

In the processing of step S205, the circuit breaker failure portion determination unit 14 determines whether the current of at least a certain value flows in the V-phase based on the V-phase AC current sensor value 50a output from the AC current sensor 50. In the case where the current of at least certain value flows in the V-phase, the circuit breaker failure portion determination unit 14 next performs the processing of step S206, and otherwise, the circuit breaker failure portion determination unit 14 next performs the processing of step S207.

In the processing of step S206, the circuit breaker failure portion determination unit 14 determines that the circuit breaker 70 of the V-phase has the conduction fixing failure. In the processing of step S207, the circuit breaker failure portion determination unit 14 determines that the circuit breaker 70 of the V-phase is normal. After the processing of step S206 or S207 is performed, the processing proceeds to step S208.

In the processing of step S208, the circuit breaker failure portion determination unit 14 performs the diagnostic operation of the conduction fixing failure of the W-phase circuit breaker 70. Specifically, as described above, with the W-phase as the diagnostic object phase and either the U-phase or the V-phase as the selection phase, the circuit breaker switching signal 14b that brings the circuit breaker 70 of the selection phase into the conduction state and brings the circuit breaker 70 of the W-phase and the circuit breaker 70 of the phase that is not the selection phase into the cutoff state is output to the circuit breaker controller 17. In addition, the duty value 14a with which the power semiconductor element 32 of the upper arm (or lower arm) of the W-phase and the power semiconductor element 32 of the lower arm (or upper arm) of the selection phase are turned on only for the short time is output to the PWM signal generator 16.

When the duty value 14a and the circuit breaker switching signal 14b are output from the circuit breaker failure portion determination unit 14, the PWM signal generator 16 generates the PWM signal 16a based on the duty value 14a and outputs the PWM signal to the driver circuit 20. In addition, the circuit breaker controller 17 controls the conduction or cutoff state of the circuit breaker 70 of each phase based on the circuit breaker switching signal 14b.

In the processing of step S209, the circuit breaker failure portion determination unit 14 determines whether the current of at least a certain value flows in the W-phase based on the W-phase AC current sensor value 50a output from the AC current sensor 50. In the case where the current of at least certain value flows in the W-phase, the circuit breaker failure portion determination unit 14 next performs the processing of step S210, and otherwise, the circuit breaker failure portion determination unit 14 next performs the processing of step S211.

In the processing of step S210, the circuit breaker failure portion determination unit 14 determines that the circuit breaker 70 of the W-phase has the conduction fixing failure. In the processing of step S211, the circuit breaker failure portion determination unit 14 determines that the circuit breaker 70 of the W-phase is normal. After the processing of step S210 or S211 is performed, the processing proceeds to step S212.

In the processing of step S212, the circuit breaker failure portion determination unit 14 generates the circuit breaker diagnostic information 14c based on the diagnostic results of the circuit breaker 70 of each phase obtained in steps S202 and S203, S206 and S207, and S210 and S211, and outputs the circuit breaker diagnostic information 14c to the state determination unit 19.

When the circuit breaker diagnostic information 14c is output from the circuit breaker failure portion determination unit 14, the state determination unit 19 changes the internal state from the “circuit breaker diagnostic state” to the “normal state” and starts the operations of the driver circuit 20 and the power conversion circuit 30.

After executing the process of step S212, the circuit breaker failure portion determination unit 14 ends the control flowchart of FIG. 17. Thus, the diagnostic operation of the circuit breaker 70 is completed.

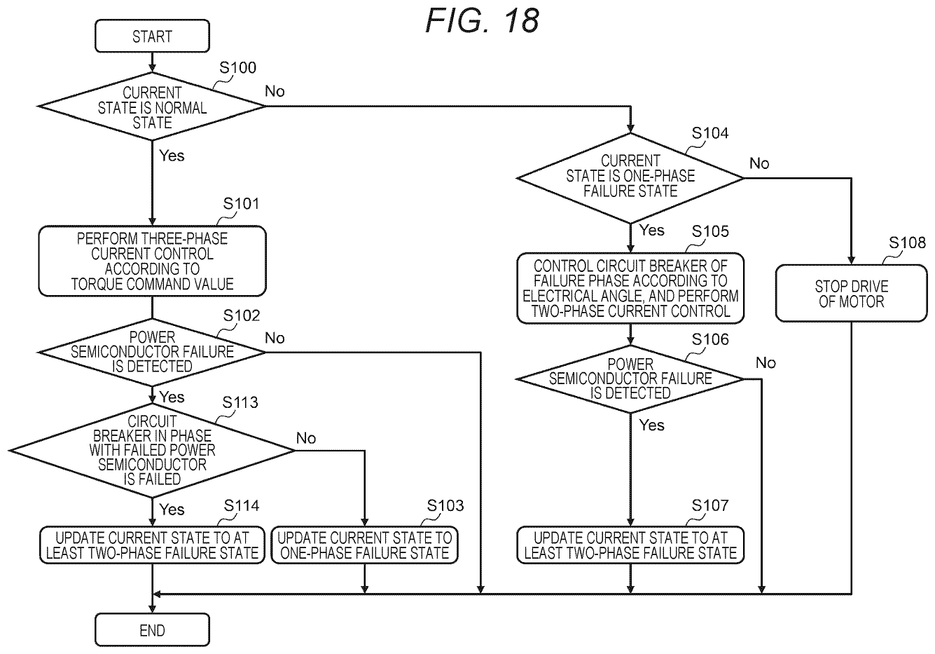

FIG. 18 illustrates an example of a control flowchart according to the fifth embodiment of the present invention. In the fifth embodiment, the control circuit 10 in FIG. 15 periodically performs the control illustrated in the flowchart of FIG. 18 at regular intervals. In FIG. 18, portions performing the same pieces of processing as those in the control flowchart of FIG. 7 described in the first embodiment are denoted by the same symbols as those in FIG. 7, and description of those pieces of processing is omitted.

In the fifth embodiment, the processing proceeds to step S113 in the case where the open failure or the short-circuit failure is detected in any one of the power semiconductor elements 32 in the processing of step S102.

In the processing of step S113, the state determination unit 19 determines whether the circuit breaker 70 in phase with the failed power semiconductor element 32 fails based on the circuit breaker diagnostic information 14c output from the circuit breaker failure portion determination unit 14 in step S212 of FIG. 17 and the power semiconductor failure information 18a output from the power semiconductor failure portion determination unit 18. As a result, the processing proceeds to step S114 in the case where it is determined in step S102 that the circuit breaker 70 in phase with the power semiconductor element 32 in which the open failure or the short-circuit failure is detected fails, and the processing proceeds to step S103 in the case where it is determined that the circuit breaker 70 of the different phase fails.

In the processing of step S114, the state determination unit 19 determines that the current state of the power conversion device 100 is the “at least two-phase failure state” and updates the internal state 19a. After executing the processing of step S114, the control circuit 10 ends the control flowchart of FIG. 18.

As described above, according to the power conversion device 100 of the fifth embodiment, the presence or absence of the conduction fixing failure of the circuit breaker 70 is determined before the operations of the driver circuit 20 and the power conversion circuit 30 are started. Then, when the failure of the power semiconductor element 32 is generated, in the case where the circuit breaker 70 in phase with the power semiconductor element 32 is in the conduction fixing failure state, the current of the failure phase cannot be cut off and the transition to the one-phase failure current control cannot be made, so that the drive of the motor 190 is stopped similarly to the case of the at least two-phase failure. For this reason, the operation corresponding to the failure of the circuit breaker 70 can be taken.

According to the fifth embodiment of the present invention described above, the power conversion device 100 includes the circuit breaker failure portion determination unit 14 that determines the failure portion of the circuit breaker 70. In the case where the power semiconductor element 32 determined to be the failure portion by the power semiconductor failure portion determination unit 18 and the circuit breaker 70 determined to be the failure portion by the circuit breaker failure portion determination unit 14 have the same phase (Yes in step S113), it is determined that the current state of the power conversion device 100 is the “at least two-phase failure state” (step S114), and the drive of the motor 190 is stopped (step S108). With this configuration, the drive of the motor 190 can be safely stopped in the case where the circuit breaker 70 fails not to be able to perform the current control at the time of one-time failure.

The present invention is not limited to the above embodiments, and various modifications are included. For example, the above embodiments are described in detail for the purpose of easy understanding of the present invention, and do not necessarily include all the described configurations. A part of the configuration of an embodiment can be replaced with the configuration of another embodiment, and the configuration of another embodiment can be added to the configuration of an embodiment. Furthermore, another configuration can be added to, deleted from, and replaced with other configurations for a part of the configuration of each embodiment. Some or all of the configurations, functions, processing units, processing measure, and the like may be designed with, for example, an integrated circuit, and implemented by hardware. Furthermore, the above-described respective configurations, functions, and the like may be implemented by software by the processor interpreting and executing a program implementing the respective functions. Information such as a program, a table, and a file, that implements each function can be stored in a memory, a recording device such as a hard disk and a solid state drive (SSD), or a recording medium such as an IC card, an SD card, and a DVD.

### REFERENCE SIGNS LIST

1 vehicle
2 driving wheel
3 non-driving wheel
4 axle
10 control circuit
11 motor speed calculation unit
11a motor speed value
12 target current calculation unit
12a target current value
13 normal-time current controller
13a duty value
14 circuit breaker failure portion determination unit
14a duty value
14b circuit breaker switching signal
14c circuit breaker diagnostic information
15 failure-time current controller
15a duty value
15b circuit breaker switching signal
16 PWM signal generator
16a PWM signal
17 circuit breaker controller
17a circuit breaker control signal
18 power semiconductor failure portion determination unit
18a power semiconductor failure information
19 state determination unit
19a internal state
20 driver circuit
20a driving signal
20b short-circuit failure detection signal
30 power conversion circuit
31 smoothing capacitor
32 power semiconductor element
33 sense terminal
33a sense current
40 voltage sensor
40a voltage sensor value
50 AC current sensor
50a AC current sensor value
60 circuit breaker drive circuit
60a circuit breaker driving signal
70 circuit breaker
100 power conversion device
190 motor
191 motor neutral point
200 drive device
210 DC power supply
220 failure notification device
230 electronic control device

1. A power conversion device comprising:
a power conversion circuit in which upper and lower arm circuits in which switching elements are connected in series are connected in parallel for at least three phases, the power conversion circuit outputting an AC current generated by the switching elements of each phase to a motor through an output line;
a circuit breaker provided on the output line of each phase to conduct or cut off the AC current;
a first failure portion determination unit that determines a failure portion of the switching element;
a circuit breaker controller that controls the circuit breaker of a failure phase such that the AC current of the failure phase is conducted at a predetermined specific electrical angle in one cycle of an electrical angle and such that the AC current of the failure phase is cut off at other electrical angles except for the specific electrical angle, with a phase corresponding to the switching element determined as the failure portion by the first failure portion determination unit as the failure phase; and
a failure-time current controller that controls drive of another switching element different from the switching element determined to be the failure portion.

2. The power conversion device according to claim 1, wherein the specific electrical angle has a range of 1200 in an electrical angle.

3. The power conversion device according to claim 1, wherein the circuit breaker controller changes the specific electrical angle for each the failure phase.

4. The power conversion device according to claim 1, wherein the circuit breaker controller instructs the circuit breaker of the failure phase to switch from a conduction state to a cutoff state before end timing of the specific electrical angle.

5. The power conversion device according to claim 1, wherein when a rotation speed of the motor is equal to or greater than a predetermined threshold, the circuit breaker controller controls the circuit breaker of the failure phase such that the AC current is cut off in an entire period of one cycle of the electrical angle, and
when the rotation speed of the motor is less than the threshold, the power conversion device controls the circuit breaker of the failure phase such that the AC current of the failure phase is conducted at the specific electrical angle and such that the AC current of the failure phase is cut off at an electrical angle other than the specific electrical angle.

6. The power conversion device according to claim 1, wherein when the switching element has an open failure,
the circuit breaker controller brings the circuit breaker of the failure phase into a conduction state, and
the failure-time current controller controls drive of the switching element of a phase different from the failure phase and a switching element of the upper and lower arm circuits in the failure phase that is not the switching element determined to be the failure portion.

7. The power conversion device according to claim 1, further comprising a second failure portion determination unit that determines a failure portion of the circuit breaker,
wherein drive of the motor is stopped when the switching element determined to be the failure portion by the first failure portion determination unit and the circuit breaker determined to be the failure portion by the second failure portion determination unit have a same phase.

8. A drive device comprising:
a power conversion device that outputs a three-phase AC current; and
a motor that is driven by the three-phase AC current,
wherein the power conversion device includes:
a power conversion circuit in which upper and lower arm circuits in which switching elements are connected in series are connected in parallel for three phases, the power conversion circuit outputting an AC current generated by the switching elements of each phase to a motor through an output line;
a circuit breaker provided on the output line of each phase to conduct or cut off the AC current;
a first failure portion determination unit that determines a failure portion of the switching element;
a circuit breaker controller that controls the circuit breaker of a failure phase such that the AC current of the failure phase is conducted at a predetermined specific electrical angle in one cycle of an electrical angle and such that the AC current of the failure phase is cut off at other electrical angles except for the specific electrical angle, with a phase corresponding to the switching element determined as the failure portion by the first failure portion determination unit as the failure phase; and
a failure-time current controller that controls drive of another switching element different from the switching element determined to be the failure portion.

9. The drive device according to claim 8, wherein the specific electrical angle has a range of 120° in an electrical angle.

10. The drive device according to claim 8, wherein the circuit breaker controller changes the specific electrical angle for each the failure phase.

11. The drive device according to claim 8, wherein the circuit breaker controller instructs the circuit breaker of the failure phase to switch from a conduction state to a cutoff state before end timing of the specific electrical angle.

12. The drive device according to claim 8, wherein when a rotation speed of the motor is equal to or greater than a predetermined threshold, the circuit breaker controller controls the circuit breaker of the failure phase such that the AC current is cut off in an entire period of one cycle of the electrical angle, and
when the rotation speed of the motor is less than the threshold, the circuit breaker controller controls the circuit breaker of the failure phase such that the AC current of the failure phase is conducted at the specific electrical angle and such that the AC current of the failure phase is cut off at an electrical angle other than the specific electrical angle.

13. The drive device according to claim 8, wherein when the switching element has an open failure,
the circuit breaker controller brings the circuit breaker of the failure phase into a conduction state, and
the failure-time current controller controls drive of the switching element of a phase different from the failure phase and a switching element of the upper and lower arm circuits in the failure phase that is not the switching element determined to be the failure portion.

14. The drive device according to claim 8, further comprising a second failure portion determination unit that determines a failure portion of the circuit breaker,
wherein drive of the motor is stopped when the switching element determined to be the failure portion by the first failure portion determination unit and the circuit breaker determined to be the failure portion by the second failure portion determination unit have a same phase.
